(19) United States
(12) Patent Application Publication
(10) Pub. No.: US 2017/0196244 A1
(43) Pub. Date: Jul. 13, 2017

(54) MODULAR DEVICES AND SYSTEMS FOR CONTINUOUS FLOW THERMAL PROCESSING USING MICROWAVES

(71) Applicant: North Carolina State University, Raleigh, NC (US)

(72) Inventor: Josip Simunovic, Raleigh (US)

(73) Assignee: North Carolina State University, Raleigh (US)

(21) Appl. No.: 15/320,676

(22) PCT Filed: Jul. 2, 2015
(86) PCT No.: PCT/US2015/039038

§ 371 Date: Dec. 20, 2016

Related U.S. Application Data
(60) Provisional application No. 62/020,202, filed on Jul. 2, 2014.

(51) Int. Cl. A23L 3/01; A23L 3/00

(52) U.S. Cl. CPC A23L 3/01; A23L 3/003; A23L 3/001; A23V 2002/00

(57) ABSTRACT

Modular systems and related methods for thermally treating flowable materials using microwave radiation, and materials obtained thereby. Also provided are modular devices for continuous flow thermal treatment of materials, methods employing the same, and products prepared using the devices and/or methods.

### RELATED APPLICATIONS

The presently disclosed subject matter claims the benefit of U.S. Provisional Patent Application No. 62/020,202, filed Jul. 2, 2014, the disclosure of which is incorporated herein by reference in its entirety.

### STATEMENT OF GOVERNMENT SUPPORT

This invention was made with government support under grant number 2012-67017-30170 awarded by the USDA National Institute of Food and Agriculture. The government has certain rights to this invention.

### TECHNICAL FIELD

The presently disclosed subject matter relates to methods and devices for thermally treating flowable materials using electromagnetic radiation, such as microwave radiation, and foods and materials obtained thereby. More particularly, the presently disclosed subject matter relates in some embodiments to methods of continuous flow thermal processing, modular systems and devices for performing the same, and products prepared using the methods, systems and/or devices.

### BACKGROUND

Microwave heating has vast applications in the field of food processing, such as cooking, drying, pasteurization, and preservation of food materials. It has the ability to achieve high heating rates, significantly reduce the cooking time, provide more uniform heating, allow safe handling, and enable ease of operation (coupled with low maintenance).

For food applications, the approved (regulated by Federal Communications Commission) and most commonly used microwave frequencies are 2450±50 and 915±15 MHz. Domestic microwave ovens operate at 2,450 MHz and industrial-heating systems use either 2,450 or 915 MHz systems. Existing industrial microwave food processing modules for heating, pasteurization and sterilization under continuous flow conditions are able to process ˜2-20 gallons per minute of liquid or semi-liquid foods, mostly using 915 MHz based microwaves. This is at a large scale and is comparatively expensive (costs of equipment per 1 kW of heating power is ˜$1000-1500, plus the cost of supporting equipment such as waveguides, microwave applicators, circulators, etc.).

Due to these high costs, the need for extensive expert support and infrastructure, and inflexibility at the lower end of the throughput scale, the existing continuous flow microwave processing (915 MHz devices) technology is out of the reach of a majority of the researchers, food processors, and developers for R&D and smaller scale production applications.

Thus, there exists a need in the art for a small range, affordable, and intermediate processing technology which can be used by the food industry for R&D purposes, by academic institutions and regulatory agencies, and individual & small business food processors. Such technology would also address the need for development of new microwave energy applications such as microwave-assisted extraction of chemical components from inorganic, organic and biomaterial matrices, catalysis and acceleration of simple and complex, single stage and multi stage chemical reactions and other complex processes where there is a need for lower level but precisely targeted delivery of volumetric heating. The availability of such technology could accelerate the developments of microwave technology applications in general and would serve to also stimulate the scale up to new developments and applications for larger industrial and higher throughput systems (for example, 915 MHz devices).

The presently disclosed subject matter addresses this and other needs in the art.

### SUMMARY

This Summary lists several embodiments of the presently disclosed subject matter, and in many cases lists variations and permutations of these embodiments. This Summary is merely exemplary of the numerous and varied embodiments. Mention of one or more representative features of a given embodiment is likewise exemplary. Such an embodiment can typically exist with or without the feature(s) mentioned; likewise, those features can be applied to other embodiments of the presently disclosed subject matter, whether listed in this Summary or not. To avoid excessive repetition, this Summary does not list or suggest all possible combinations of such features.

Provided in some embodiments of the presently disclosed subject matter is a thermal treatment system for a flowable material, the system comprising: (a) at least two microwave cavities; (b) an energy source for delivering electromagnetic energy, such as 2450±50 MHz microwave energy, to each of the at least two identical microwave cavities; (c) a controller for controlling the level of power delivery independently for each of the at least two microwave cavities; (d) a microwave transparent conduit, optionally a cylindrical conduit, adapted for fluid communication with the at least two microwave cavities to transport a flowable material through the at least two microwave cavities; (e) a pump for pumping, optionally continuously pumping, a flowable material through the microwave-transparent conduit; and (f) a component for measuring and/or recording a temperature of a flowable material subsequent to the exposure to electromagnetic energy in the at least two microwave cavities. It is provided however that in some embodiments, the electromagnetic energy is not 915±15 MHz microwave energy.

Provided in some embodiments is a method of treating a flowable material. In some embodiments the method comprises sequentially exposing the material under continuous flow conditions to electromagnetic energy, such as 2450±50 MHz microwave energy, within at least two microwave cavities while flowing through a conduit, optionally a cylindrical conduit, comprising a microwave-transparent material. It is provided however that in some embodiments, the electromagnetic energy is not 915±15 MHz microwave energy. In some embodiments, a product produced by any of the presently disclosed methods is provided.

In some embodiments, the at least two microwave cavities are multi-mode microwave cavities. In some embodiments, the at least two microwave cavities are identical or are dissimilar. In some embodiments, the system comprises at least two identical and at least one dissimilar multi-mode microwave cavities.

In some embodiments, a mixing structure is disposed within or along the conduit to provide mixing subsequent to the exposure of the flowable material to electromagnetic energy in the at least two microwave cavities. In some embodiments, the mixing structure comprises one or more passive mixing structures, one or more active mixing structures, or both.

In some embodiments, a reactor is in fluid communication with the conduit to receive the flowable material subsequent to the exposure of the flowable material to electromagnetic energy in the at least two microwave cavities. In some embodiments, the reactor comprises a mixing structure, optionally an active mixing structure.

In some embodiments, the system further comprises a mobile enclosure or frame. In some embodiments, the mobile enclosure or frame comprises wheels. In some embodiments, the system is enclosed within a mobile enclosure or frame.

In some embodiments, a hold tube is adapted for fluid communication with the conduit. In some embodiments, the system comprises a packaging device for one of packaging the flowable material for refrigerated storage, aseptically packaging the flowable material for ambient temperature storage (e.g., shelf stability), non-aseptically (e.g., hot filling) the flowable material for ambient temperature storage (e.g., shelf stability), and both packaging the flowable material for refrigerated storage and aseptically packaging the flowable material for ambient temperature storage (e.g., shelf stability). In some embodiments, the system comprises a pre-treating device for providing a pre-treatment to the flowable material prior to the exposure to electromagnetic energy, optionally wherein the pre-treatment is heating, coagulation, mixing, chemical reactions between native or added ingredients, or any combination of the foregoing.

In some embodiments, the method comprises mixing the flowable material subsequent to the exposure to electromagnetic energy in the at least two microwave cavities. In some embodiments, the mixing employs one or more passive mixing structures, one or more active mixing structures, or both. In some embodiments, the method comprises flowing the flowable material to a reactor in fluid communication with the conduit to receive the flowable material subsequent to the exposure of the flowable material to electromagnetic energy in the at least two microwave cavities. In some embodiments the reactor comprises a mixing structure, optionally an active mixing structure. In some embodiments, the method comprises holding the flowable material in a hold tube adapted for fluid communication with the conduit. In some embodiments, the method comprises one of packaging the flowable material for refrigerated storage, aseptically packaging the flowable material, and both packaging the flowable material for refrigerated storage and aseptically packaging the flowable material. In some embodiments, the method comprises a pre-treating the flowable material prior to the exposure to electromagnetic energy, optionally wherein the pre-treatment is heating, coagulating, mixing, or any combination of the foregoing.

In some embodiments, the flowable material is exposed to the treatment by any one of the components comprising the system more than once (recirculation). In some embodiments, the flowable material is selectively exposed to the treatment by more than one of the components comprising the system more than once (recirculation).

In some embodiments, the flowable material is selected based on at least one of rheological, dielectric, and thermophysical properties, or combinations thereof, of the flowable material. In some embodiments, the flowable material is a biomaterial, such as a food biomaterial. In some embodiments, the food biomaterial is selected based on at least one of rheological, dielectric, and thermo-physical properties, or combinations thereof, of the food biomaterial.

Provided in some embodiments is a commercially sterile biomaterial comprising comminuted protein rich material and having one or more quality attributes that is preserved to a greater extent as compared to a reference biomaterial that has been sterilized using a reference thermal treatment method. In some embodiments, the one or more quality attributes is selected from the group consisting of nutrient content, color, texture, flavor and general appearance.

Also provided in accordance with some embodiments of the presently disclosed subject matter are all methods, processes, devices, systems, apparatuses, kits, materials, compositions and/or uses shown and/or described expressly or by implication in the information provided herewith, including but not limited to features that may be apparent and/or understood by those of skill in the art.

Accordingly, it is an object of the presently disclosed subject matter to provide a modular system for thermal processing and methods employing the same. This and other objects are achieved in whole or in part by the presently disclosed subject matter.

An object of the presently disclosed subject matter having been stated above, other objects and advantages of the presently disclosed subject matter will become evident as the description proceeds when taken in connection with the accompanying drawings as best described herein below.

### BRIEF DESCRIPTION OF THE DRAWINGS

The presently disclosed subject matter can be better understood by referring to the following figures. The components in the figures are not necessarily to scale, emphasis instead being placed upon illustrating the principles of the presently disclosed subject matter (often schematically). In the figures, like reference numerals designate corresponding parts throughout the different views. Although the illustrated embodiment is merely exemplary of systems for carrying out the presently disclosed subject matter, both the organization and method of operation of the presently disclosed subject matter, in general, together with further objectives and advantages thereof, may be more easily understood by reference to the drawings and the following description. The drawings are not intended to limit the scope of this presently disclosed subject matter, which is set forth with particularity in the claims as appended or as subsequently amended, but merely to clarify and exemplify the presently disclosed subject matter.

FIG. 1 is a schematic drawing showing heating segments/stages in a continuous flow thermal processing system using modular 2450 megahertz (MHz) microwaves in accordance with an embodiment of the presently disclosed subject matter.

FIG. 2 is a schematic drawing showing a hybrid continuous flow thermal processing system in accordance with an embodiment of the presently disclosed subject matter, which employs additional heating and modular 2450 megahertz (MHz) microwaves.

FIG. 3 is a schematic drawing showing a hybrid continuous flow thermal processing system in accordance with an embodiment of the presently disclosed subject matter, which employs additional heating and modular 2450 megahertz (MHz) microwaves.

FIG. 4 is a schematic drawing showing a single-stage, single-pass 2,450 megahertz (MHz) microwave preheater for a continuously-stirred reactor.

FIG. 5 is a schematic drawing showing a multi-stage, single-pass 2,450 megahertz (MHz) microwave preheater for a continuously-stirred reactor.

FIG. 6 is a schematic drawing showing a single-stage, multi-pass (recirculated) 2,450 megahertz (MHz) microwave heater/continuously-stirred reactor.

FIG. 7 is a schematic drawing showing a multi-stage, multi-pass (recirculated) 2,450 megahertz (MHz) microwave heater/continuously-stirred reactor.

FIG. 8 is a schematic drawing showing a hybrid continuous flow thermal processing system in accordance with an embodiment of the presently disclosed subject matter, wherein the sequence of preparation, processing, and packaging of protein-rich products using continuous flow 2,450 megahertz (MHz) microwave treatment for preservation is employed.

FIG. 9 is a schematic drawing showing a hybrid continuous flow thermal processing system in accordance with an embodiment of the presently disclosed subject matter, wherein a sequence of preparation, processing and packing of protein-rich products using optional continuous flow heating and continuous flow 2,450 megahertz (MHz) microwave treatment for preservation is employed.

FIGS. 10A-10D are schematic diagrams of exemplary mixing devices, with a capability to provide a mechanical mixing effect preceding, concurrent (such as in a microwave cavity) and/or subsequent to heating.

FIG. 11 is a plot showing the dependence of optimal diameters for a microwave-transparent conduit for continuous flow microwave treatment of a variety of foods on the dielectric loss tangent, under 3 most frequently applied microwave frequencies in household and industrial use.

FIG. 12A is a plot showing optimal diameters versus the measured dielectric loss tangent for one of the analyzed five (5) groups of flowable foods at a frequency of 460 MHz: Cheese and Pasta Sauces.

FIG. 12B is a plot showing optimal diameters versus the measured dielectric loss tangent for one of the analyzed 5 groups of flowable foods at a frequency of 460 MHz: Puddings, Formulas and Nutritional Beverages.

FIG. 12C is a plot showing optimal diameters versus the measured dielectric loss tangent for one of the analyzed 5 groups of flowable foods at a frequency of 460 MHz: Vegetable Purees and Blends.

FIG. 12D is a plot showing optimal diameters versus the measured dielectric loss tangent for one of the analyzed 5 groups of flowable foods at a frequency of 460 MHz: Soups and Meals.

FIG. 12E is a plot showing optimal diameters versus the measured dielectric loss tangent for one of the analyzed 5 groups of flowable foods at a frequency of 460 MHz: Fruits and Fruit Purees.

FIG. 13A is a plot showing optimal diameters versus the measured dielectric loss tangent for one of the analyzed 5 groups of flowable foods at a frequency of 915 MHz: Cheese and Pasta Sauces.

FIG. 13B is a plot showing optimal diameters versus the measured dielectric loss tangent for one of the analyzed 5 groups of flowable foods at a frequency of 915 MHz: Puddings, Formulas and Nutritional Beverages.

FIG. 13C is a plot showing optimal diameters versus the measured dielectric loss tangent for one of the analyzed 5 groups of flowable foods at a frequency of 915 MHz: Vegetable Purees and Blends.

FIG. 13D is a plot showing optimal diameters versus the measured dielectric loss tangent for one of the analyzed 5 groups of flowable foods at a frequency of 915 MHz: Soups and Meals.

FIG. 13E is a plot showing optimal diameters versus the measured dielectric loss tangent for one of the analyzed 5 groups of flowable foods at a frequency of 915 MHz: Fruits and Fruit Purees.

FIG. 14A is a plot showing optimal diameters versus the measured dielectric loss tangent for one of the analyzed 5 groups of flowable foods at a frequency of 2450 MHz: Cheese and Pasta Sauces.

FIG. 14B is a plot showing optimal diameters versus the measured dielectric loss tangent for one of the analyzed 5 groups of flowable foods at a frequency of 2450 MHz: Puddings, Formulas and Nutritional Beverages.

FIG. 14C is a plot showing optimal diameters versus the measured dielectric loss tangent for one of the analyzed 5 groups of flowable foods at a frequency of 2450 MHz: Vegetable Purees and Blends.

FIG. 14D is a plot showing optimal diameters versus the measured dielectric loss tangent for one of the analyzed 5 groups of flowable foods at a frequency of 2450 MHz: Soups and Meals.

FIG. 14E is a plot showing optimal diameters versus the measured dielectric loss tangent for one of the analyzed 5 groups of flowable foods at a frequency of 2450 MHz: Fruits and Fruit Purees.

FIGS. 15-18 are photographs illustrating a first prototype of a single flow-through microwave heating system in accordance with the presently disclosed subject matter and components thereof.

FIG. 19 is a plot of recirculation testing with salted water at 2 liters per minute flow rate in a first generation prototype of a continuous flow 2450 MHz microwave heating device—single oven.

FIG. 20 is a plot of recirculation testing with spaghetti sauce at 2 liters per minute flow rate in a first generation prototype of a continuous flow 2450 MHz microwave heating device—single oven.

FIG. 21 is a plot of recirculation testing with apple sauce at 2 liters per minute flow rate in a first generation prototype of a continuous flow 2450 MHz microwave heating device—single oven.

FIG. 22 is a plot of recirculation testing with muscadine grape homogenate at 2 liters per minute flow rate in a first generation prototype of a continuous flow 2450 MHz microwave heating device—single oven.

FIG. 23 is a plot of recirculation testing with muscadine smoothie beverage at 2 liters per minute flow rate in a first generation prototype of a continuous flow 2450 MHz microwave heating device—single oven.

FIG. 24 is a plot of recirculation testing with blueberry homogenate at 2 liters per minute flow rate in a first generation prototype of a continuous flow 2450 MHz microwave heating device—single oven.

FIG. 25 is a plot of recirculation testing with strawberry homogenate at 2 liters per minute flow rate in a first generation prototype of a continuous flow 2450 MHz microwave heating device—single oven.

FIGS. 26 and 27 are photographs of a second generation prototype of a continuous flow 2450 MHz microwave heating system in accordance with the presently disclosed subject matter, and components thereof.

FIG. 28 is a plot of recirculation testing with sweet potato puree at 1 liter per minute flow rate in a second generation prototype of a continuous flow 2450 MHz microwave heating device—four ovens in series.

FIG. 29 is a plot of recirculation testing with sweet potato puree at 2 liters per minute flow rate in a second generation prototype of a continuous flow 2450 MHz microwave heating device—four ovens in series.

FIG. 30 is a plot of recirculation testing with 2% milk at 1 liter per minute flow rate in a second generation prototype of a continuous flow 2450 MHz microwave heating device—four ovens in series.

FIG. 31 is a plot of recirculation testing with 2% milk at 2 liters per minute flow rate in a second generation prototype of a continuous flow 2450 MHz microwave heating device—four ovens in series.

FIG. 32 is a plot of recirculation testing with brewer's yeast precipitate at 1 liter per minute flow rate in a second generation prototype of a continuous flow 2450 MHz microwave heating device—four ovens in series.

FIG. 33 is a plot of recirculation testing with brewer's yeast precipitate at 2 liters per minute flow rate in a second generation prototype of a continuous flow 2450 MHz microwave heating device—four ovens in series.

FIG. 34 is a plot of recirculation testing with cucumber pickle relish at 1 liter per minute flow rate in a second generation prototype of a continuous flow 2450 MHz microwave heating device—four ovens in series.

FIG. 35 is a plot of recirculation testing with cucumber pickle relish at 2 liters per minute flow rate in a second generation prototype of a continuous flow 2450 MHz microwave heating device—four ovens in series.

FIG. 36 is a plot of recirculation testing with cheese sauce at 1 liters per minute flow rate in a second generation prototype of a continuous flow 2450 MHz microwave heating device—four ovens in series.

FIG. 37 is a plot of recirculation testing with cheese sauce at 2 liters per minute flow rate in a second generation prototype of a continuous flow 2450 MHz microwave heating device—four ovens in series.

FIG. 38 is a plot of recirculation testing with tomato sauce at 2 liters per minute flow rate in a second generation prototype of a continuous flow 2450 MHz microwave heating device—four ovens in series.

FIG. 39 is a plot of recirculation testing with pineapple puree at 2 liters per minute flow rate in a second generation prototype of a continuous flow 2450 MHz microwave heating device—four ovens in series.

FIG. 40 is a plot of recirculation testing with strawberry homogenate at 2 liters per minute flow rate in a second generation prototype of a continuous flow 2450 MHz microwave heating device—four ovens in series.

FIG. 41 is a plot of recirculation testing with muscadine grape homogenate at 2 liters per minute flow rate in a second generation prototype of a continuous flow 2450 MHz microwave heating device—four ovens in series.

FIG. 42 is a plot of recirculation testing with diced tomatoes in tomato juice at 2 liters per minute flow rate in a second generation prototype of a continuous flow 2450 MHz microwave heating device—four ovens in series.

FIG. 43 is a photograph of a mobile third generation prototype system in accordance with the presently disclosed subject matter comprising three modules comprising three (3) microwave cavities each.

FIGS. 44-45 are photographs of a fourth generation prototype system in accordance with the presently disclosed subject matter integrating an inline active mixing device with a vertical module comprising three (3) microwave cavities at 2450 MHz.

FIGS. 46-55 are photographs showing four vertical modules in a system in accordance with the presently disclosed subject matter providing a refrigerated processing room.

FIG. 56 is a plot of the flowing meat paste temperatures in degrees C. at entry and exit points of each module plus temperature of the paste in the receiving container based on the system shown in FIGS. 46-55.

### DETAILED DESCRIPTION

In some embodiments the presently disclosed subject matter employs commercial microwave ovens (e.g., 2450±50 MHz) in both mono- and multi-modular systems producing uniform and gentle heating energy (for example, 1 kW per foot-length of conduit). The presently disclosed subject matter can provide processing flow rates ranging from approximately 1 L/min to 5 L/min. Additionally, in some embodiments, the cost of the presently disclosed subject matter is anticipated to be no more than $350/-per kW of heating power, including all necessary equipment, like sanitary, microwave transparent, high temperature, and high pressure tubing.

The presently disclosed subject matter provides for the advanced thermal processing equipment to a wider population of food and biomaterial product developers and processors. Due to the high cost, high complexity and requirements for extensive expert support and infrastructure of the currently available continuous flow microwave processing equipment (915 MHz devices), this advanced technology remains out of the reach of a large majority of researchers, processors and developers. Availability of a modular, appropriately dimensioned, easily controllable, mobile and reasonably priced systems of 2450 MHz microwave heating devices provides for the innovation of new high quality and high nutritional value food and biomaterial products, and contributes momentum to the movement of process and product development in this area away from the old conventional processing systems towards the more energy efficient, nutritionally superior, flavorful new product lines. Representative applications include the food and biomaterial processing equipment market, R&D operations, test contract run services and assistance with product development and sample generation for market testing, and small and intermediate processing and production operations.

Food processing industry is the largest industrial complex globally, with the annual value exceeding trillions of dollars. The drivers to the more advanced processing systems and technologies for foods are numerous—energy efficiency, economic considerations, the push for quality improvement and maximization of nutrient retention in food products. More recently, the move away from the canned foods caused by the multiple controversies over Bisphenyl-A (aka BPA) and its wide ranging negative effects on human health has accelerated the efforts to introduce and implement novel, continuous flow oriented processing technologies to a wider range of processed food products.

The food processing industry, primarily small and medium capacity start-ups processing operations, as well as R&D divisions and laboratories in larger companies, are representative candidates for employing the presently disclosed subject matter. Also, companies in the bioprocessing areas can have unique and demanding requirements on their thermal processing systems.

Unless otherwise defined, all technical and scientific terms used herein have the same meaning as commonly understood by one of ordinary skill in the art to which this presently described subject matter belongs. Although any methods, devices, and materials similar or equivalent to those described herein can be used in the practice or testing of the presently disclosed subject matter, representative methods, devices, and materials are now described. All publications, patent applications, patents, and other references mentioned herein are incorporated by reference in their entirety, including but not limited to the following: U.S. Pat. Nos. 6,797,929; 6,583,395; 6,406,727; 6,265,702; 6,121,594; 6,087,642; and 5,998,774; U.S. Patent Application Publications 20030205576 and 20010035407; and PCT International Patent Application Publications WO 0143508; WO 0184889; and WO 0036879.

### I. MODULAR ADVANCED FLOW THERMAL PROCESSING SYSTEMS

Modular advanced continuous flow thermal processing systems are provided herein, and can be employed in the processing of flowable materials, such as but not limited to foods and biomaterials, ranging from simple heating to blanching, pre-processing, pasteurization, sterilization, extraction, gelation, coagulation, pre-drying thermal treatments, etc.—i.e. any thermal treatment which can conventionally be implemented under continuous flow conditions. Combinations of individual heating modules allow assembly of processing capacities ranging from pilot plant/R&D installations, to semi-industrial, and small to intermediate industrial capacity installations. In some embodiments of the presently disclosed subject matter, individual modular units implement assemblies of commercial microwave ovens integrated into flow-through installations using high temperature, high pressure sanitary, microwave transparent conduits for flowable material transport and handling.

The presently disclosed subject matter enables the use of advanced thermal processing (for example, continuous flow microwave heating) at throughput levels not currently possible with the available (915 MHz based MW) technologies, which typically cover throughputs of 2-20 gallons per minute. The presently disclosed subject matter enables processing flow rates ranging from approximately 1 liter per minute to approximately 5 liters per minute. This enables applications in the small to intermediate processing range, which has the potential to bring the advantages of continuous flow microwave heating to a dynamic and innovative field of new product developments—conversion of small start-up and concept development production up to full production levels at cost efficient levels.

There are several other significant advantages—compared to the industrial, 915MHz microwave systems, where the cost of equipment per 1 kW of heating power is $1,000 to $1,500 plus the cost of supporting equipment like waveguides, microwave applicators, circulators etc., in some embodiments the cost of the presently disclosed subject matter using commercial microwave ovens (2450MHz) is anticipated to be no more than $350 per kW of heating power, including all necessary equipment, such as but not limited to sanitary, microwave transparent, high temperature, and high pressure tubing. Another advantage is the distribution of heating energy more uniformly and gently over the heated conduit flow-through length (approximately 1 kW per foot—length of conduit), as opposed to all current applications of 915 MHz microwave heating which result in very high energy density at the point of initial first application—ranging from ˜30 kW to ˜75 kW or more—this extreme energy density of application can tend to cause localized overheating, boiling, deposit formation and eventual tube failures via arcing or melting—resulting in failed production runs and inferior, flavor tainted products.

Another advantage is the easy mobility (modules as described can be enclosed in mobile enclosures, optionally on wheels) and the convenient ability to reconfigure processing systems containing the modular assemblies—so in such cases where additional power i.e. additional modules are justified in the process, the process line can be disconnected at any point due to the use of standard sanitary stainless connectors and conduits (Tri-Clover™ clamps, fittings and gaskets) and additional modules can be added before the entry, after the exit or at any convenient intermediate point within the original processing sequence.

Additionally, due to the light construction, mobility and small size of individual modules, processing systems can if needed be conveniently disassembled at the original processing and easily re-assembled and operationally implemented at another processing location. This is of particular relevance and use for processing of materials which are seasonal and may need to be processed close to the original harvesting location in order to maximize the preservation of fresh flavors and nutrients. Common examples of this type of processing would be fruits sensitive to transportation and mechanical damage caused by it such as grapes, berries, melons etc.

Yet another advantage is the ability to assemble the processing systems incorporating the modular microwave units into more complex multi component assemblies including other processing elements such as mixing, blending, grinding, homogenization, cooling, packaging etc. into complete turn-key processing assemblies which can be integrated into small mobile production facilities. These production facilities could be based on a standard container base and distributed and relocated as needed using standard tractor trailers, ship, and/or converted buses or military purposed vehicles. Such systems could also include power, steam and cooling energy sources in order to provide complete mobile, operational units incorporating one or more modular microwave elements. By way of example, in some embodiments, a system in accordance with the presently disclosed subject matter can comprise a base/enclosure of the standard truck-loadable or ship-loadable container type where the top or the walls could be removed/reattached so that the container can be assembled and reassembled quickly and easily in order to transport the system to other locations. A representative application would be for on-the-field processing of crops—for example strawberry season starts in Mexico, moves to Florida, Georgia, Alabama and other southern states and progresses north as the summer progresses, ending up in Vermont and Maine at the end of the season. Systems in accordance with the presently disclosed subject matter could therefore be used to migrate south to north as the season migrates.

Many different food and biomaterials can benefit significantly from the implementation of the presently disclosed subject matter and examples are provided herein. For example, provided is the final shelf stable packaging of the products such as meat based and animal organ based homogenized products like pates, blood sausages, and products from pork and beef hearts, livers, kidneys, fat and skins.

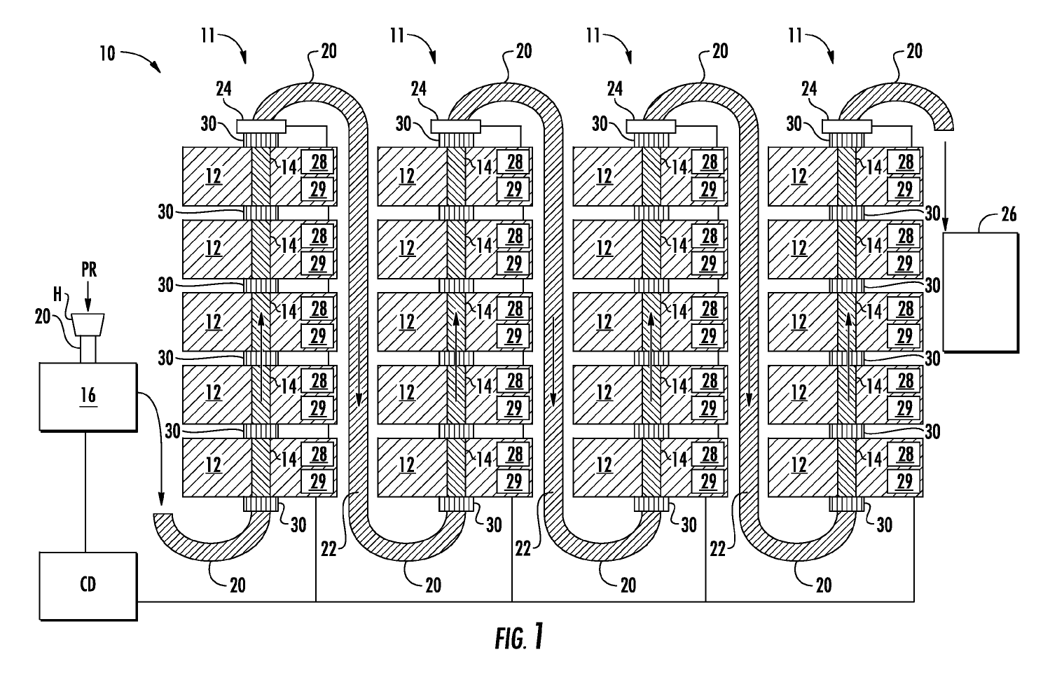

Referring now to the drawings, wherein like reference numerals refer to like parts throughout, and referring particularly to FIGS. 1-9, a system in accordance with the presently disclosed subject matter is referred to generally at 10. System 10 comprises at least two microwave cavities 12. In the embodiments show in FIGS. 1-9, system 10 comprises at least one module 11, in some embodiments, four modules 11. In some embodiments, each module 11 comprises four microwave cavities 12. Thus, in the embodiments show in FIGS. 1-3, 5, and 7-9, system 10 comprises 20 microwave cavities 12. Each microwave cavity 12 includes an energy source 28 with a controller 29 for delivering electromagnetic energy, such as 2450±50 MHz microwave energy, to each of the microwave cavities 12. It is provided however that in some embodiments, the electromagnetic energy is not 915±15 MHz microwave energy.

In some embodiments, microwave cavities 12 are multi-mode microwave cavities. In some embodiments, microwave cavities 12 are identical or are dissimilar. In some embodiments, system 10 comprises at least two identical and at least one dissimilar multi-mode microwave cavities.

In the embodiments shown in FIGS. 1-9, each microwave cavity 12 has its own controller 29 and each controller 29 can control the level of power delivery independently for each of microwave cavities 12. In some embodiments, system 10 comprises a control device CD that can be programmed to communicate with and independently control each energy source 28 for each microwave cavity 12. For example, system 10 can comprise a control device CD that can be programmed to communicate with and independently control each controller 29 to thereby control energy source 28 for each microwave cavity 12.

Continuing with references to FIGS. 1-9, microwave transparent conduits 14, optionally cylindrical, provide for fluid communication with and between microwave cavities 12 to transport a flowable material PR through the microwave cavities 12. A representative microwave transparent conduit can comprise an internal polypropylene, polymethylpentene, polysulfone, polyetherimide, TEFLON® polymer, or any other microwave-transparent polymer, ceramic or glass tube optionally encased in a cylindrical shell comprising borosilicate glass, ceramic, another microwave-transparent polymer or multiple layers of microwave-transparent materials. A pump 16, which can be a sanitary positive displacement pump, such as might be available from Fristam (Middleton, Wis., USA), Waukesha/Cherry-Burell (Delavan, Wis., USA), Moyno (Springfield, Ohio, USA), Seepex (Enon, Ohio, USA), etc., is provided for pumping, optionally continuously pumping and/or recirculating, a flowable material PR through microwave-transparent conduits 14 and indeed through system 10 as a whole. Thus, in some embodiments, the flowable material is exposed to the treatment by any one of the components comprising the system more than once. In some embodiments, the flowable material is selectively exposed to the treatment by more than one of the components comprising the system more than once.

Continuing with reference to FIGS. 1-9, in some embodiments, flowable material PR is loaded into a hopper H, which is connected to pump 16 via tubing section 20. Pump 16 can be controlled, such by control device CD, to provide desired flow rates as disclosed herein, such as but not limited to approximately 1 liter per minute, approximately 2 liters per minute, approximately 3 liters per minute, approximately 4 liters per minute, and/or approximately 5 liters per minute. System 10 also comprises a component 24 for measuring and/or recording a temperature of a flowable material subsequent to the exposure to electromagnetic energy in microwave cavities 12. An example of component 24 is a thermocouple temperature probe array, such as might be available from Windridge Sensors, USA or Ellab A/S, Denmark. Depending on the configuration of system 10, component 24, which can comprise a thermocouple temperature probe array, is used to measure the cross sectional temperature profiles at the exit of modules 11 and/or individual microwave cavities 12.

Continuing with reference to FIGS. 1-9, pump 16 is connected to a microwave cavity 12 and a microwave transparent conduit 14 via tubing 22 and connector 30. Microwave transparent conduits 14 are connected to microwave cavities 12 and component 24 via connectors 30. Each module 11 is connected via tubing sections 20 and 22 and connectors 30. Optionally, tubing sections 20 and 22 and connector 30 comprise stainless steel.

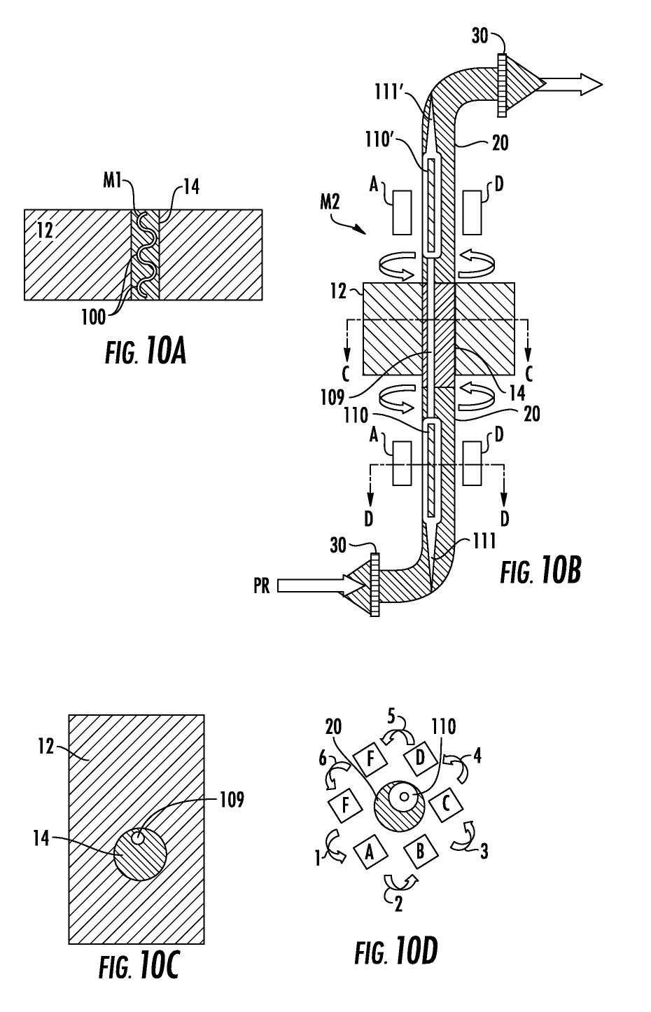

Referring now to FIGS. 10A-10D, system 10 can include an exemplary mixing device or devices, referred to as M1 and M2 Mixing devices M1 and M2 can provide mechanical mixing effects in a target location (preceding, concurrent and/or subsequent to heating) at the same time and using the same device. Referring to FIG. 10A, mixing device M1 comprises static mixing elements 100, and mechanical mixing effects can be achieved by extending mixing device M1 throughout a region of system 10, for example, microwave transparent conduits 14 in microwave cavities 12. Mixing device M1 is fabricated from a MW-transparent material, such as those disclosed elsewhere herein.

Referring to FIGS. 10B-10C, mixing device M2 comprises mixing element 109, and mechanical mixing effects can be achieved by extending mixing element 109 throughout a region of system 10, for example, microwave transparent conduits 14 in microwave cavities 12 and adjacent tubing sections 20. Although not show in FIGS. 10B-10C, a mixing device such as a mixing device M2 can provide mixing to an entire module 11 of system 10. Mixing element 109 is fabricated from a MW-transparent material, such as those disclosed elsewhere herein, and provides a concurrently rotating and orbiting movement within the exposure region, ensuring that no configuration is static and minimizing the likelihood of overheating and/or runaway heating within the transparent tube or chamber.

Continuing now with reference to FIGS. 10B-10D, the material to be heated PR enters the heating segment through tubing section 20, which can be connected to system 10 (not shown as a whole in FIGS. 10B-10D) via connectors 30. Material PR continues through tubing sections 20 and microwave transparent tube segment 14 where it undergoes heating delivered by microwave cavity 12, and mixing with mixing device M2 before and after heating. Mixing device M2 further comprises ferromagnetic mixer cores 110, 110′, which can be cylindrical and can be encased either in stainless steel or TEFLON®. Mixing element 109 is attached to ferromagnetic cores 110, 110′ at the edge of their cylindrical perimeters. Stainless steel spacer elements 111, 111′ are attached to ferromagnetic cores 110, 110′ opposite mixing element(s) 109 and maintain the vertical position of core 110, 110′ and element 109, taking advantage of the upwardly moving push of the incoming material and the centrifugal pulling force of one of the four to eight externally radially-positioned electromagnets a-f. Electromagnets a-f are switched on one at a time and the power is cycled (steps 1-6 are repeated continuously). Power and control can be provided in any suitable manner, such as but not limited to through control device CD (not shown in FIGS. 10B-10D). This results in a radial and rotational movement of ferromagnetic mixer cores 110, 110′ and a rotating as well as orbiting movement of mixer element 109. This provides a mixing action within the microwave cavity 12 without obstructing the microwave energy distribution for any length of time at any individual point along its path: the radial position of mixing element 109 as well as its position along the internal perimeter of the straight stainless steel tube portion 20 of the flow path constantly change. The rate of the change of this position and therefore the rate of mixing action can be controlled by increasing or decreasing the speed of electromagnet switching steps 1 through 6. Cylindrical ferromagnetic mixer cores 110, 110′ as well as stainless steel Optionally, single or multiple temperature monitoring fixtures (e.g. temperature sensor components 24 as disclosed herein) can be used at mixer entry and exit locations to monitor and confirm the achieved temperature increases and distributions.

Continuing with reference to FIG. 1, a module 11 can be connected to a post-treatment component 26 via a tubing section 20 and a connector 30. As schematically represented in FIG. 1, post-treatment component 26 can include any desired component as would be apparent to one of ordinary skill in the art upon a review of the instant disclosure, such as but not limited to a hold tube and/or a packaging device for one of packaging the flowable material for refrigerated storage, aseptically packaging the flowable material, and both packaging the flowable material for refrigerated storage and aseptically packaging the flowable material.

### II. HYBRID SYSTEMS FOR CONTINUOUS FLOW THERMAL PROCESSING FOR TREATMENT OF PUMPABLE FOODS AND BIOMATERIALS (HEATING, PASTEURIZATION, STERILIZATION) USING MODULAR 2450 MHZ MICROWAVE EQUIPMENT

The presently disclosed subject matter provides in some embodiments approaches and devices for delivering the final heat treatment for continuous flow thermal processing operations used in heating, pasteurization and/or sterilization of foods and biomaterials. In some embodiments, the presently disclosed systems for advanced continuous flow volumetric heating enable the replacement and/or enhancement of the final stage of heating to achieve rapid heating in order to maximize the quality and throughput of existing both conventional and advanced heating (ohmic, microwave or radio frequency) installations. In some embodiments the presently disclosed subject matter employs multiple modular microwave units to deliver the final thermal treatment stage (such as at 10° C. temperature difference or less).

Current continuous flow thermal processing installations for food and biomaterials used in the industry whether conventional or advanced, have to address the difficulty of delivering the final stage of heating—in conventional systems, due to the reduced driving force (temperature difference) at the high temperature end, extended lengths and times of exposure are needed to achieve the desired final temperature level. Therefore, the quality degradation of the food or biomaterial products occurring during the last 10 degrees or less of heating can be extensive. The presently disclosed subject matter provides for the minimization of exposure to high temperatures at the final level, and accelerates the heating rate due to the improved coupling of advanced electromagnetic heating to the material and enhanced conversion to thermal energy with the increasing temperature levels of processed materials.

For continuous flow thermal processing systems which already implement some form of advanced or volumetric heating (ohmic, microwave or radio frequency) there can be different reasons to use the presently disclosed hybrid systems. For these systems, it is difficult to control the final temperature level since at high volume and mass throughputs, high energy fields need to be generated and implemented in order for product to achieve the safe final level of treatment, especially in pasteurization and sterilization types of treatment. With these high energy density systems, there are operational issues with frequent overheating, bio-deposit formation on the tube walls and final system failure due to tube failure. There is a particular risk of this for materials containing ingredients such as proteins, starches, pectins and other macro-molecules, where an abrupt and poorly controlled change in temperature can lead to denaturation, precipitation, gel formation or dissolution, phase change, loss and migration of fluid from solid to the fluid components of the product etc.

In these cases, the presently disclosed subject matter can reduce the energy density delivered via the initial advanced/volumetric heating and enable improved control of these processes.

The presently disclosed subject matter provides for the replacement at the high temperature end, and using the described modular systems, the incremental energy delivery is gradual rather than abrupt, and controllability is improved compared to when high power generators need to be used for heating.

Finally, the presently disclosed subject matter can be used in other combined configurations—typically conventional heating followed by some form of advanced/volumetric heating and finally continuous flow heating using modular microwave systems.

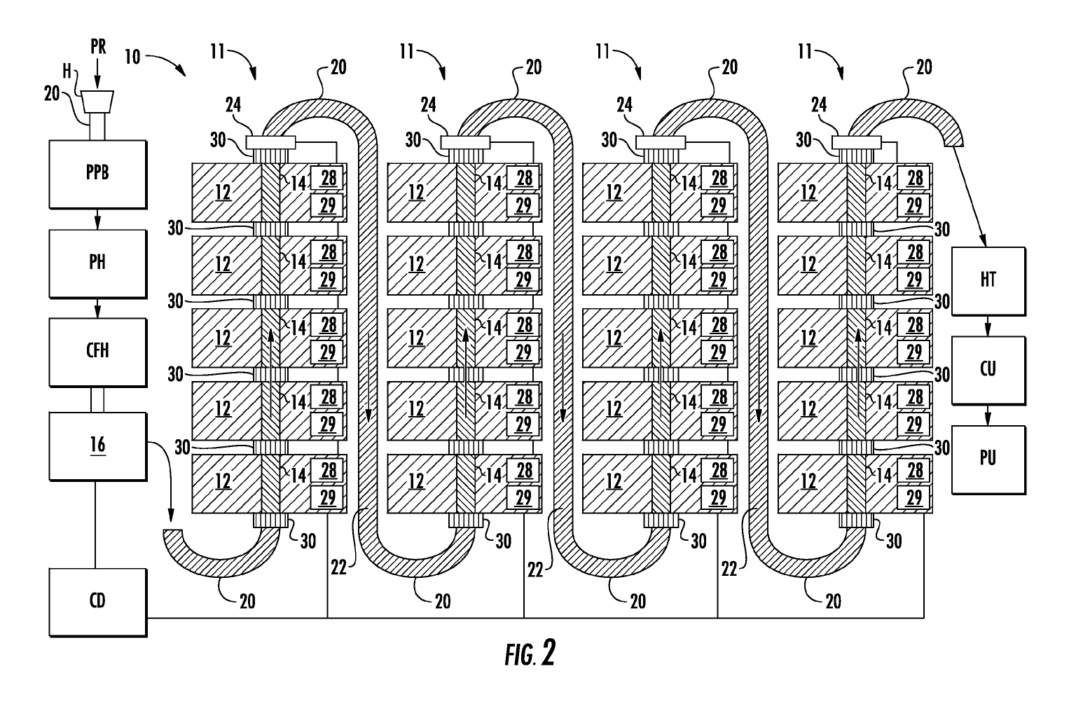

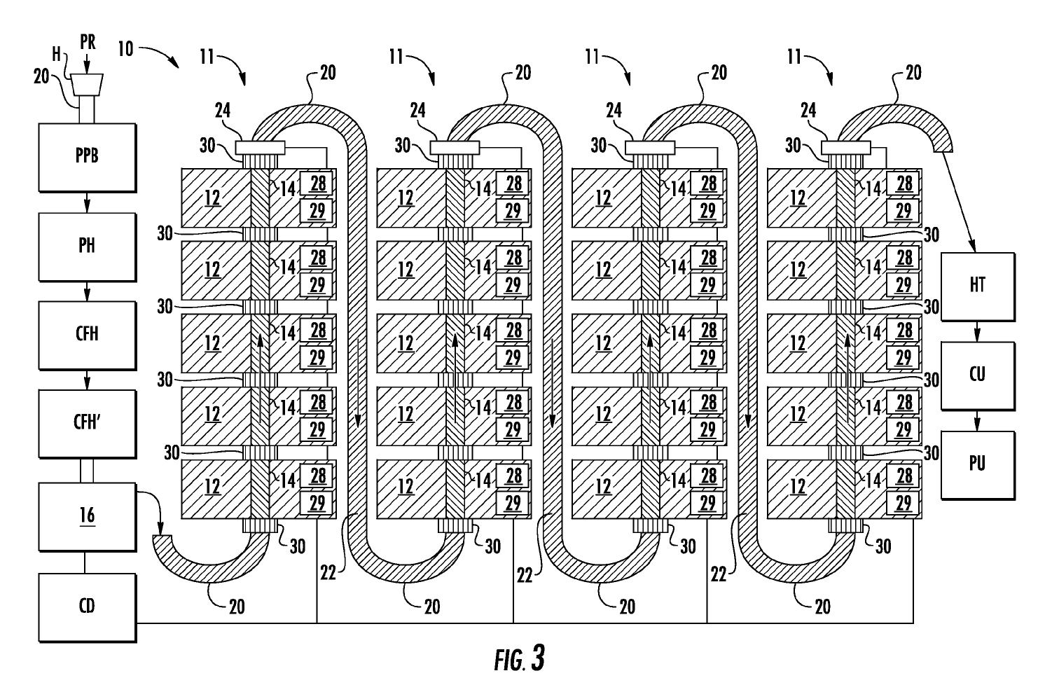

Referring particularly to FIGS. 2 and 3, flowable material PR is loaded into a hopper H, which is connected via tubing section 20 to an apparatus for product-preparation and blending PPB, such as a hopper, vat or other vessel. System 10 can further include a heater PH to provide for pre-heating of the product PR to be treated. Product PR can then be transported into a continuous flow heater or heaters CFH and/or CFH′ (as shown in FIG. 3). Representative examples of continuous flow heater CFH and CFH′ include conventional heat exchangers, such as plate, tube-in-tube, tube-in-shell, helical multitude, scraped surface, steam injection, steam infusion, and the like; ohmic heaters; radiofrequency (Rf) heaters; microwave heaters such as 915 MHz heaters; and any combination thereof. After heat treatment using continuous flow heater(s) CFH and/or CFH′, product PR is then pumped via pump 16 into module or modules 11 for processing as described herein above, through to a continuous flow hold tube HT for holding at temperature. Product PR is then pumped into continuous flow cooling unit CU to allow for desired cooling, which can facilitate packaging in packaging unit PU.

### III. MICROWAVE (2450 MHZ) BASED PRE-HEATERS AND CONTINUOUSLY RECIRCULATED HEATERS FOR BATCH VESSEL (CONTINUOUSLY STIRRED) REACTORS FOR CHEMICALS, BIOCHEMICAL, FOODS AND OTHER BIOMATERIALS

In some embodiments the presently disclosed subject matter provides methods and systems for pre-heating and/or in-line heating for chemicals, biochemical, foods and biomaterials processed in batch-type, optionally continuously stirred reactors.

In some embodiments the presently disclosed subject matter provides methods and devices for the application of 2450 MHz to enable, accelerate and/or optimize chemical and/or biochemical reactions performed under controlled conditions in pressurized vessels, such as stainless steel vessels, known as continuously stirred reactors. The capability for rapid volumetric heating using robust but relatively inexpensive equipment can provide initial standards for simple microwave heated reaction vessels. Microwave assisted, accelerated or catalyzed chemical reactions have been the subject of intensive research and development activity but typically at a very small scale and volume levels (bench top scale). Managed applications of modular 2450 MHz microwave systems in accordance with the presently disclosed subject matter can provide the pathway for the scale-up to pilot plant and semi-industrial installations and capacities for these evolving processes.

The presently disclosed subject matter provides methods and systems for the application of microwave heating prior to and during the treatment of chemicals, biochemical, foods and/or biomaterials in batch-type reactors at a scale and throughput heretofore unavailable. It enables the volumetric (direct) heating of the reactant mass preceding or concurrently with the reaction. In addition to the rapid heating, the advantages include simplicity, modular design enabling the increase in the rate of heating or the throughput/capacity of the system as needed.

In some embodiments the presently disclosed subject matter provides specialized applications such as maceration, protein denaturation, component extraction, isomerization, polymerization etc.

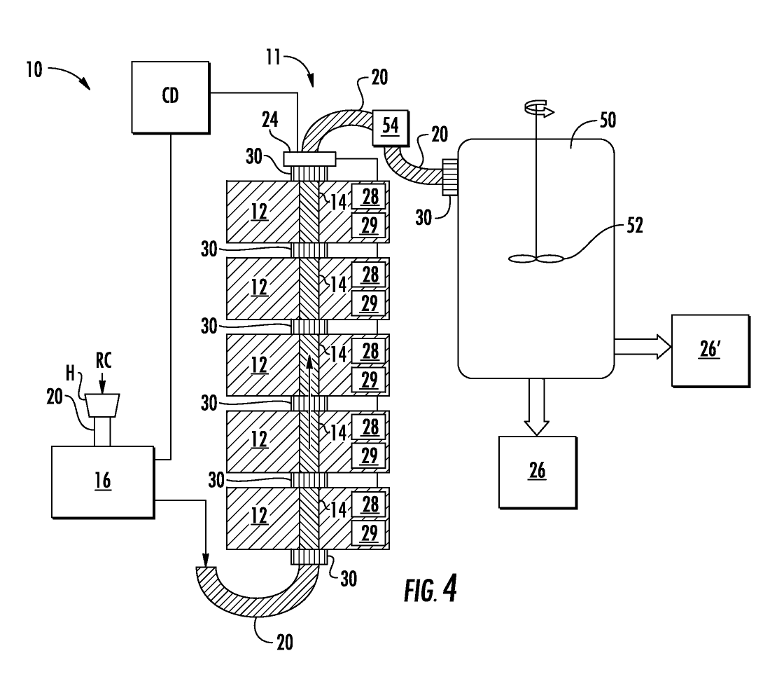

FIGS. 4-7 show representative flow installations. FIGS. 4-7 illustrate several different configurations and embodiments of the presently disclosed subject matter. The single-pass configurations enable the preheating of the reactants using 2450 MHz microwave heating prior to loading them into the reactor, with single or multiple modules implemented depending on the desired capacity or the required rate of heating.

The multi-pass (recirculated) configurations enable continuous recirculation and heating of the reactants pre-loaded into the reaction vessel and circulated out of the vessel, through the microwave heating stage and back into the vessel providing and gradual but rapid increase in temperature of the reaction mixture. Similarly to the single-pass configurations, multi-stage (multi-module) configurations can be used to deliver the increased rates of heating or treatment to increased volumes of processed reactants in a volumetric heating mode, without the need for the process material to be exposed to overheated surfaces of the conventional type heat exchangers.

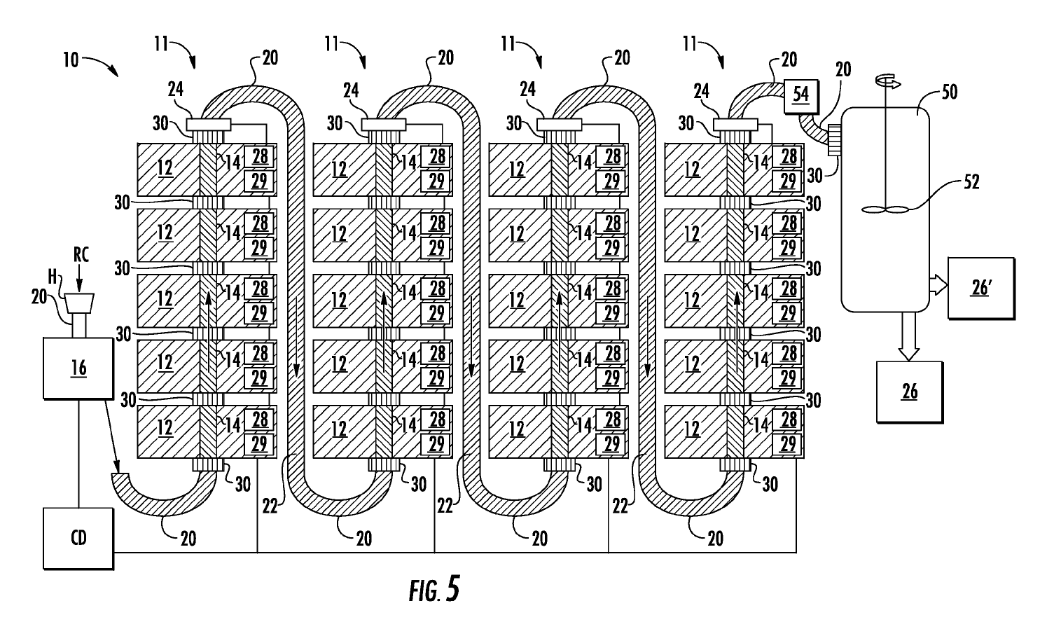

Referring now to FIGS. 4-5, a reactant or reactants RC are loaded into a hopper H and flow through a tubing section 20 into pump 16. Pump 16 then pumps reactants RC via a tubing section 20 into module or modules 11 for treatment as described herein above. Desired heating parameters are controlled via power supplies 28 and controllers 29, which can further be controlled by control device CD. Pump 16 and stirrer 52 are also controlled by control device CD. Reactants RC flow into the reactor 50 after heat treatment. In reactor 50 heated reactants RC are stirred continuously via stirrer 52 until a desired reaction/treatment is complete. Reaction/treatment products and/or byproducts are recovered in post-treatment component 26 or 26′ for desired processing, such as described elsewhere herein.

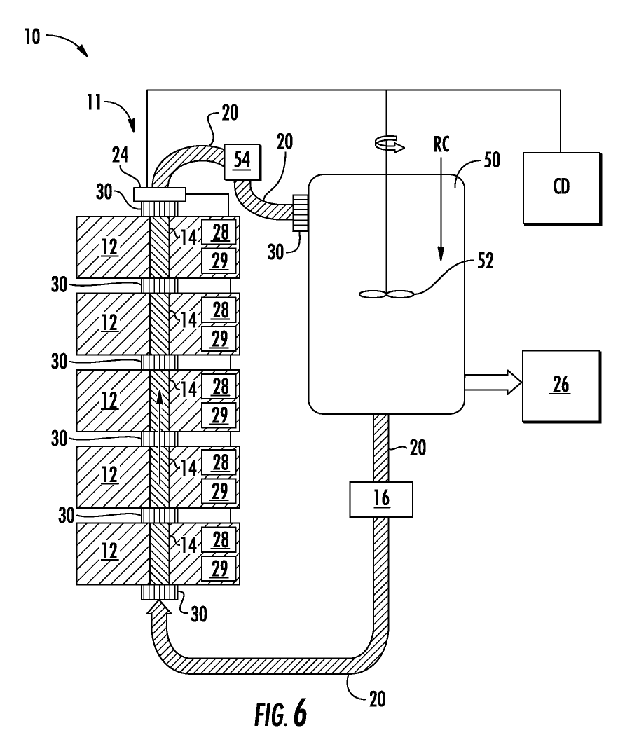

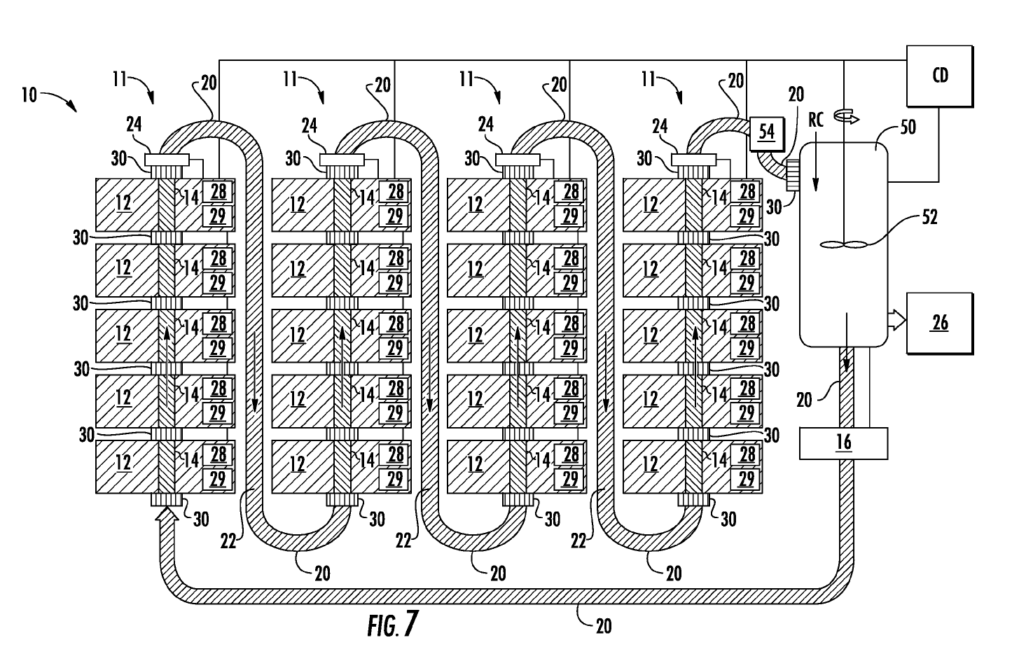

Referring now to FIGS. 6 and 7, representative embodiments involving the circulation and recirculation of reactants are shown. Particularly, reactants RC are loaded directly into reactor 50 under stirring via stirrer 52. Reactants RC then flow via tubing section 20 to pump 16 and are pumped into module or modules 11 for heat treatment as described herein. Particularly, desired heating parameters are controlled via power supplies 28 and controllers 29, which can further be controlled by control device CD. Pump 16 and stirrer 52 are also controlled by control device CD. Reactants RC are circulated through system 10 in accordance with desired or predetermined flow rates, such as those disclosed elsewhere herein, until they return to reactor 50. This circulation can be repeated one or more times. After appropriate circulation and/or heat treatment, and the associated heat-induced or heat-assisted treatments or reactions, desired products are removed and recovered in post-treatment component 26 for further processing as desired, such as described elsewhere herein.

Optionally, an in-line cooling device can be added into the processing loop. Referring again to FIGS. 4-7, system 10 can optionally comprise in-line cooling device 54. In-line cooling device 54 can comprise a single or multi-stage indirect conventional heat exchanger such as tube in tube, plate, tube in shell or multi-pass etc.). Cooling device 54 can be used, for example, in situations where either overheating of the reaction mixture is detected—typically in exothermic reactions in order to prevent product loss or degradation due to excessive temperatures generated, or equipment or system failure caused by increased temperatures and the related internal pressure levels. In-line cooling device 54 can also be used to reduce the temperature of the reaction mixture as part of a designed protocol or a multi-stage processing sequence. This would be applicable in cases where sequential reactions or treatments are anticipated at temperatures lower than reactions or treatments earlier in the processing sequence. Finally, the combinations of temperature increase sequences and temperature decrease sequences which are anticipated as needed would be delivered by alternating or concurrent implementation of microwave energy using modular microwave units and continuous flow cooling elements. The operation of both microwave heating and continuous flow cooling elements can be controlled from the single control unit/system (for example, control device CD in FIGS. 4-7).

### IV. EXTENDED SHELF LIFE AND SHELF STABLE HIGH PROTEIN, VALUE-ADDED FOOD PRODUCTS BASED ON ANIMAL AND VEGETABLE PROTEIN SOURCES AND METHODS OF THEIR PRODUCTION

In some embodiments the presently disclosed subject matter provides a family of extended shelf life and shelf stable new protein rich products preserved using the modular microwave heating systems disclosed herein. Typical products in this category are high protein content meat-based spaghetti sauces, taco sauces, meat-based chili sauces, sausage bits in gravy, sandwich meats in sauce, etc. There is also an extremely wide range of options for blending with non-meat animal sources of proteins like dairy, eggs, fish, seafood etc. as well as vegetable sources of proteins (beans, soy, mushrooms, nuts etc.).

In some embodiments the presently disclosed subject matter provides methods for production of a range of products using the application of 2450 MHz microwave thermal treatment for heating, pasteurization and/or sterilization. The products preserved in this manner provide unique sensory, functional and nutritional characteristics due to the rapid, substantially uniform volumetric thermal treatment followed by rapid cooling. No similar products are currently available in the format made possible by the presently disclosed subject matter.

In some embodiments the presently disclosed subject matter provides for the application of microwave heating to prepare a range of protein rich products that are currently not available in the retail marketplace and are typically prepared fresh in home or restaurant environments, (e.g. a reference treatment method). A reference treatment method can also be a conventional heat treatment method such as one of those mentioned at several locations herein. The implemented technology and processes of the presently disclosed subject matter can result in a unique, superior sensory and nutritional quality of produced products and address the need for production and expanded accessibility of protein rich food products. The range of products also provides for delivery of better optimized formulations, which can include more nutritious and environmentally superior sources of protein such as dairy, egg or vegetable while maintaining the high level of preferred flavor and other sensory characteristics.

In addition to the presently described range of products based on comminuted (very small particles) of protein dense materials (5% or higher protein content or 1 gram of protein per 20 or less calories, the presently disclosed subject matter can be adapted to products containing larger and more discrete particles of protein rich ingredients in the future.

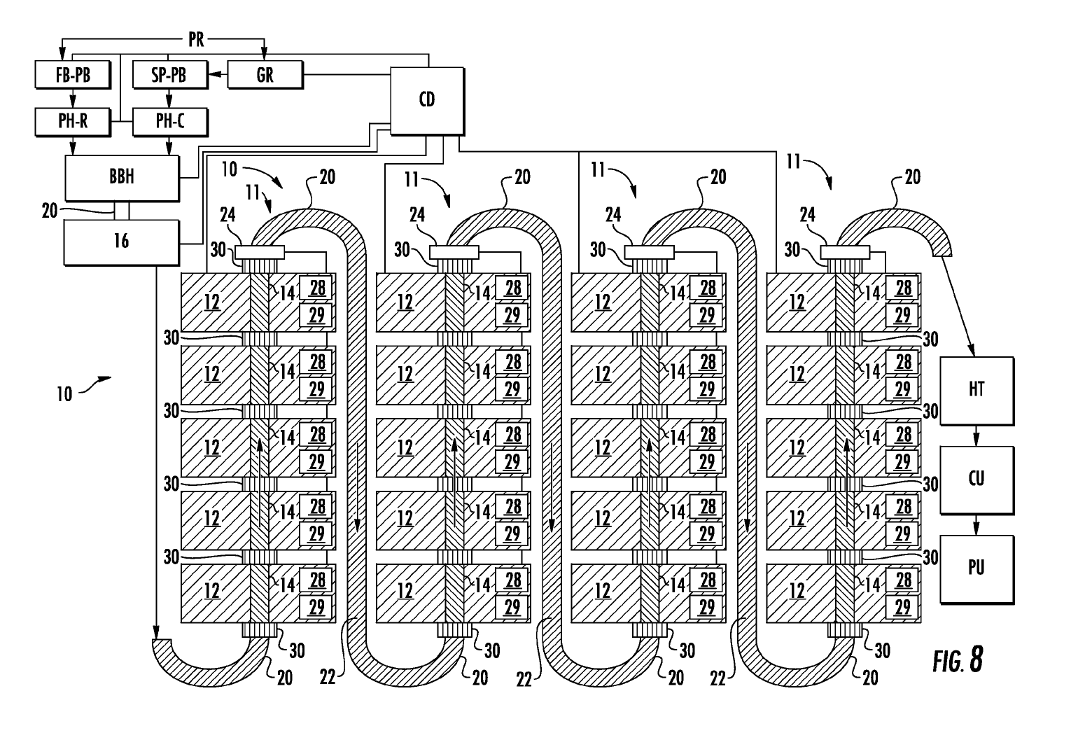

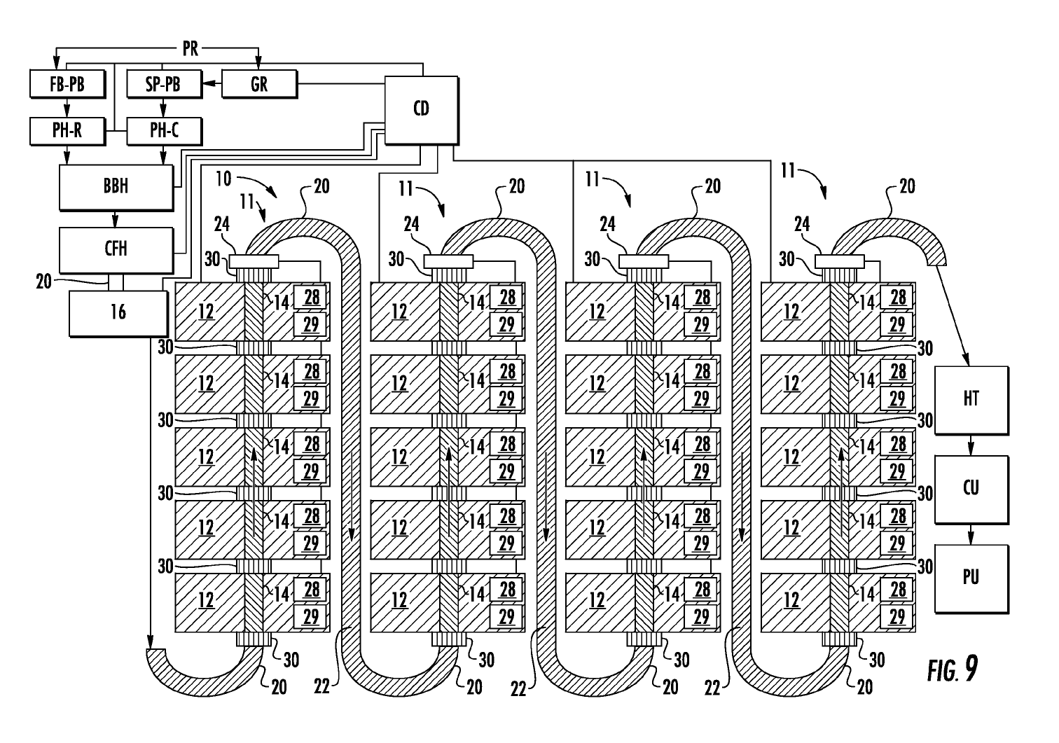

Referring particularly to FIGS. 8 and 9, a protein-rich flowable material PR is loaded into a grinding/particle size reduction apparatus GR and/or a fluid/puree carrier preparation and blending apparatus FB-PB, such as a hopper, vat or other vessel. System 10 can further include a small animal protein foods and/or vegetable protein preparation and blending apparatus SP-PB, such as a hopper, vat or other vessel, in flow communication with grinding/particle size reduction apparatus GR. System 10 can further include a heater PH-R to provide for pre-heating and/or reduction and a heater PH-C to provide for pre-heating and/or coagulation of the product PR to be treated. Product PR can then be transported blender/batch heating apparatus BBH for blending and additional heating, such as to provide a suspension. Product PR can then be transported into a continuous flow heater CFH (as shown in FIG. 9). Representative examples of continuous flow heater CFH and CFH′ include conventional heat exchangers, such as plate, tube-in-tube, tube-in-shell, helical multitude, scrape surface, steam injection, steam infusion, and the like. The addition of this optional stage of pre-heating using conventional tube in tube or scraped surface heat exchangers can be advantageous in particular for production systems with higher capacity.

Continuing with reference to FIG. 9, after blending in blender/batch heating apparatus BBH or heat treatment using continuous flow heater CFH, product PR is then pumped through tubing section 20 via pump 16 into module or modules 11 for processing as described herein above, through to a continuous flow hold tube HT for holding at temperature. Product PR is then pumped into continuous flow cooling unit CU to allow for desired cooling, which can facilitate packaging in packaging unit PU.

### V. DEFINITIONS

While the following terms are believed to be well understood by one of ordinary skill in the art, the following definitions are set forth to facilitate explanation of the presently claimed subject matter.

Following long-standing patent law convention, the terms “a”, “an”, and “the” refer to “one or more” when used herein, including in the claims.

As used herein, the term “about”, when referring to a value or an amount, for example, relative to another measure, is meant to encompass variations of in some embodiments ±20%, in some embodiments ±10%, in some embodiments ±5%, in some embodiments ±1%, and in some embodiments ±0.1% from the specified value or amount, as such variations are appropriate. The term “about” can be applied to all values set forth herein.

As used herein, the term “and/or” when used in the context of a listing of entities, refers to the entities being present singly or in combination. Thus, for example, the phrase “A, B, C, and/or D” includes A, B, C, and D individually, but also includes any and all combinations and sub-combinations of A, B, C, and D.

The term “comprising”, which is synonymous with “including,” “containing,” or “characterized by” is inclusive or open-ended and does not exclude additional, unrecited elements or method steps. “Comprising” is a term of art used in claim language which means that the named elements are present, but other elements can be added and still form a construct or method within the scope of the claim.

As used herein, the phrase “consisting of” excludes any element, step, or ingredient not specified in the claim. When the phrase “consists of” appears in a clause of the body of a claim, rather than immediately following the preamble, it limits only the element set forth in that clause; other elements are not excluded from the claim as a whole.

As used herein, the phrase “consisting essentially of” limits the scope of a claim to the specified materials or steps, plus those that do not materially affect the basic and novel characteristic(s) of the claimed subject matter.

With respect to the terms “comprising”, “consisting of”, and “consisting essentially of”, where one of these three terms is used herein, the presently disclosed and claimed subject matter can include the use of either of the other two terms.

As used herein, “significance” or “significant” relates to a statistical analysis of the probability that there is a non-random association between two or more entities. To determine whether or not a relationship is “significant” or has “significance”, statistical manipulations of the data can be performed to calculate a probability, expressed in some embodiments as a “p-value”. Those p-values that fall below a user-defined cutoff point are regarded as significant. In some embodiments, a p-value less than or equal to 0.05, in some embodiments less than 0.01, in some embodiments less than 0.005, and in some embodiments less than 0.001, are regarded as significant.

The presently disclosed subject matter provides in some embodiments a continuous flow method for thermally treating a flowable material. As used herein, the term “flowable material” refers to any material that can be flowed from one point to another in a substantially uniform manner. For example, in some embodiments, a flowable material can be moved from one place to another under laminar flow. In some embodiments, a flowable material comprises a highly viscous/semi-solid material that is shear thinning or shear thickening characterized with a yield stress.

In some embodiments the biomaterial is selected based on the rheological, dielectric, and thermo-physical properties of the biomaterial. In some embodiments, the biomaterial has one or more characteristics selected from the group consisting of high starch content, high protein content, high solids content, a high viscosity (for example, a viscosity at about 25° C. that renders conventional thermal treatment processes undesirable), and low thermal conductivity (for example, (less than 1 W/m•K). Representative yield stress of thick/viscous foods or biomaterials are presented in Table 1.

TABLE 1
Yield Stress of Fluid Foods

| | | Measurement | |
|---|---|---|---|
| Product | σₒ (Pa) | Method | Source |
| Ketchup | 22.8 | Extrapolation | Ofoli et al., 1987 |
| Mustard | 34.0 | Extrapolation | Ofoli et al., 1987 |
| Miracle Whip | 54.3 | Extrapolation | Ofoli et al., 1987 |
| Apricot puree | 17.4 | Extrapolation | Ofoli et al., 1987 |
| Milk chocolate | 10.9 | Extrapolation | Ofoli et al., 1987 |
| Minced fish paste | 1600-2300 | Extrapolation | Nakayama et al., |
| | | | 1980 |
| Mayonnaise | 24.8-26.9 | stress to initiate | De Kee et al., 1980 |
| | | flow | |
| Ketchup | 15.4-16.0 | stress to initiate | De Kee et al., 1980 |
| | | flow | |
| Tomato paste | 83.9-84.9 | stress to initiate | De Kee et al., 1980 |
| | | flow | |
| Raw meat batter | 17.9 | Extrapolation | Toledo et al., 1977 |
| Tomato puree | 23.0 | stress decay | Charm, 1962 |
| Applesauce | 58.6 | stress decay | Charm, 1962 |
| Tomato paste | 107-135 | squeezing flow | Campanella & |
| | | | Pelegi, 1987 |
| Ketchup | 18-30 | squeezing flow | Campanella & |
| | | | Pelegi, 1987 |
| Mustard | 52-78 | squeezing flow | Campanella & |
| | | | Pelegi, 1987 |
| Mayonnaise | 81-91 | squeezing flow | Campanella & |
| | | | Pelegi, 1987 |
| Applesauce | 45-87 | squeezing flow | Campanella & |
| | | | Pelegi, 1987 |
| Applesauce | 46-82 | vane method | Qui & Rao, 1988 |
| Ketchup | 26-30 | vane method | Missaire et al., 1990 |
| Spaghetti sauce | 24-28 | vane method | Missaire et al., 1990 |
| Tomato puree | 25-34 | vane method | Missaire et al., 1990 |
| Pumpkin filling | 20 | vane method | Missaire et al., 1990 |
| Applesauce | 38-46 | vane method | Missaire et al., 1990 |
| Baby food, pears | 49 | vane method | Missaire et al., 1990 |
| Baby food, peaches | 25 | vane method | Missaire et al., 1990 |
| Baby food, carrots | 71 | vane method | Missaire et al., 1990 |
| See also Steffe, 1996. | | | |

As used herein, the term “thermally treating” and grammatical variants thereof refer to exposing a flowable material (for example, a biomaterial) to conditions whereby the temperature of all of the flowable material, either over time or upon exposure to modular electromagnetic radiation, is increased to an appropriate level to effect the treatment. In some embodiments, a thermal treatment is designed to pasteurize or sterilize a biomaterial.

As used herein, the terms “pasteurization” and “pasteurized” refer to treatments sufficient to kill sufficient pathogenic microorganisms contained within the biomaterial being treated to render the biomaterial edible or otherwise administrable to a subject without threat of infection by, for example, Salmonella, Listeria, enteropathogenic E. coli or other pathogenic microorganisms. Pasteurization can be thought of as a treatment that, for all practical purposes, renders pathogenic microorganisms into a state in which they are incapable of reproducing or growing under refrigerated conditions. Pasteurization methods cause in some embodiments at least a four log cycle reduction, in some embodiments at least a six log cycle reduction, and in some embodiments at least a nine log cycle reduction, of bacteria in the product.

As used herein, the term “ultrapasteurization” refers to pasteurization that results in a pasteurized product with a salable shelf life under ambient or refrigerated conditions (e.g., 4° C. or less, but above freezing) greater than that obtainable using previously known pasteurization methods. See e.g.,

U.S. Pat. No. 4,808,425 (the disclosures of all patents cited herein are incorporated herein in their entireties). As used herein, the phrase “salable shelf life” refers to an amount of time that a product can be stored and/or available for sale to a consumer before some characteristic that changes during storage alters the product to an extent that would make the product unappealing to the consumer. Representative characteristics that can change during storage of a product include, but are not limited to color levels, viscosity levels, taste characteristics, aromas, and microbial levels. Thus, ultrapasteurization methods produce extended salable shelf life products: for example, products having shelf lives of in some embodiments more than 10 days, in some embodiments more than 14 days, in some embodiments 4 to 6 weeks, and in some embodiments up to 36 weeks or more.

In some embodiments, ultrapasteurization refers to a) sterilizing the contact surface area of the processing unit prior to introduction of the biomaterial, b) providing a thermal treatment to the biomaterial greater than that normally associated with pasteurization but less than would be considered commercially sterile, although treatments in the range of the commercially sterile range can be used, c) packaging in an Extended Shelf Life (ESL) filler and/or aseptic filler and d) maintaining the product under refrigeration during storage. Ultrapasteurized product is not considered a low-acid shelf stable product requiring a no rejection letter from the US Food and Drug Administration allowing production but must be refrigerated and has a limited shelf life.

In some embodiments, the thermal treatment results in a biomaterial that is shelf stable. As used herein, the term “shelf stable” refers to a biomaterial that can be stored for extended periods of time at room temperature without spoilage or microbial growth when compared to the same biomaterial that had not been thermally treated as described herein. A shelf stable biomaterial can be stored at room temperature for in some embodiments more than 10 days, in some embodiments more than 14 days, in some embodiments 4 to 6 weeks, and in some embodiments up to 36 weeks or more without spoilage or microbial growth. It is not uncommon for shelf stable commercially sterile product to have shelf lives of one year or greater.

Shelf stable and commercially sterile can be used interchangeably for the purpose of the presently disclosed subject matter. Elements include a) sterilizing the contact surface area of the processing unit prior to introduction of the biomaterial, b) providing a thermal treatment to the biomaterial that eliminates the risks, within statistical limits, for the growth of microorganisms and their spores, at ambient temperatures c) packaging in hermetically sealed containers using an aseptic filler and d) maintaining the product at ambient temperature during distribution storage. Low-acid shelf stable product requires a no rejection letter from the US Food and Drug Administration allowing production.

It should be noted that “shelf stable” and “salable shelf life” are not necessarily interchangeable terms. For example, a product can be shelf stable for a period of time that exceeds its salable shelf life. Given that certain changes that can occur to a product over time are unrelated to microbial growth and can negatively affect a salable shelf life, a given product's salable shelf life is typically shorter than the time period during which is it otherwise shelf stable.

The term “aseptic packaging” or packaged in an aseptic filler means to the exclusion of microorganisms and their spores other than those carried by the product itself. Aseptic packaging fillers are pre-sterilized prior to production runs. In some embodiments, the aseptic packaging material is pre-sterilized prior to the introduction of heat-treated biomaterial.

By the term “biomaterial”, it is meant that any material that includes a biological component, such as a protein, starch, or sugar. Representative biomaterials are those amenable to processing using a thermal process, such as a continuous flow thermal process. In some embodiments, a biomaterial is a food or a food product.

The term “biomaterial” is also meant to refer to solid or fluid materials or products that are susceptible to deviations from a standard quality or characteristic if exposed to certain environmental conditions, or if not properly treated so as to reach the standard characteristic or quality. In some embodiments, “biomaterial” refers to a food material. The term “biomaterial” is thus also meant to include a material or product that is to be ingested by or introduced into a consumer.

Foods and other biomaterials, for example, are susceptible to deviations from a standard quality or characteristic. Microbial growth in the food or other biomaterial contained in a package can occur if, among other things, the food or other biomaterial in the package is not properly refrigerated or is not thermally treated to a sufficient level to kill microbes and their spores within the food or other biomaterial. Microbial growth produces deviations in a characteristic in the food or other biomaterial from a standard characteristic. For example, microbial growth can produce gases within a package containing a food or other biomaterial. The gases, mainly carbon dioxide produced by microbial metabolic processes, represent a deviation from a standard characteristic of the food or other biomaterial in a like package in that no such gases should be present in a standard quality food or other biomaterial in a like package. Further, the microbial growth itself can represent a deviation for the standard, that is, no microbial growth.

Other examples of a “biomaterial” include pharmaceuticals, blood and blood products, and personal health products like shampoo. While personal health care products like shampoo are not meant to be ingested by a consumer, they usually include a biological component like a protein.

By the term “characteristic”, it is meant a feature of the biomaterial or of the package for a biomaterial. Particularly, the term “characteristic” is meant to describe a feature of the biomaterial or of the package of biomaterial that determines whether or not the biomaterial or package is suitable for use by and/or ingestion by a consumer. The term “quality attribute” can include any characteristic disclosed herein that might be desirable for a given biomaterial. The term “quality profile” can thus refer to any combination of characteristics, or quality attributes, disclosed herein that might be desirable for a given biomaterial.

By the term “standard characteristic”, it is meant, then, a characteristic of the biomaterial and/or package for a biomaterial which indicates that the biomaterial and/or package for a biomaterial is suitable for use by a consumer. In some embodiments, the term “standard characteristic” can mean a standard or a quality level for a given characteristic against which unknown characteristics can be compared.

For example, the characteristic and the standard characteristic of the biomaterial can each comprise a characteristic of the composition of the biomaterial. As used herein, a “characteristic” can be a “quality attribute”, which is intended to refer to a characteristic of the biomaterial that when varied affects the desirability of the treated biomaterial for the consumer. Representative quality attributes include, but are not limited to, nutrient content, color, texture, flavor, general appearance, fat content, water composition, and combinations thereof.

As used herein, the term “thermal equalization” refers to a condition whereby the temperature of a biomaterial is substantially uniform through a chosen region (for example, a cross section). Thus, “thermal equalization” is a state wherein the temperature distribution variability across the chosen region is minimized. While it is not required that the temperature of the chosen region be within any set number of degrees, thermal equalization can encompass temperature variability of in some embodiments not more than 20° C., in some embodiments not more than 15° C., in some embodiments not more than 10° C., in some embodiments not more than 8° C., in some embodiments not more than 6° C., in some embodiments not more than 5° C., in some embodiments not more than 3° C., and in some embodiments not more than 1° C. Alternatively, thermal equalization can be expressed in terms of a percent variability through a chosen region (for example, a cross section). Thus, a percent variability can encompass in some embodiments less than a 20%, in some embodiments less than a 15%, in some embodiments less than a 10%, in some embodiments less than an 8%, in some embodiments less than a 5%, in some embodiments less than a 3%, in some embodiments less than a 2%, and in some embodiments less than a 1% difference between the highest and the lowest temperatures present within the chosen region.

In some embodiments, thermal equalization encompasses temperature differences that are small enough such that the minimum temperature is sufficient to accomplish the goals of the thermal treatment without negatively affecting characteristics of interest of the biomaterial at any site within the chosen region.

In some embodiments, mixing the flowable material facilitates thermal equalization. In some embodiments, mixing is accomplished by static or dynamic change of shape, profile and/or area size of the cross-section of the flow-through region of a conduit, preceding, concurrent or subsequent to heating/exposure to electromagnetic energy. Shape can refer to the cross-sectional geometry of the conduit, which can be varied from round to elliptical to triangular etc.; change in profile can refer to the inclusion of inserts such as single or multiple mixing bars, shafts, or other such protrusions; and size of the area can refer to an increase or decrease in the flow-through diameter of the conduit as well as variations in the flow-through area by having different cross sections and/or attachments to the mixing bars or static flow obstructions.

As is well known in the art, by the term “hermetically sealed”, it is meant any sealing process wherein a package including a material (e.g., a biomaterial) is sealed to the exclusion of microbes and their spores. In the case of a biomaterial, the biomaterial is treated prior to sealing, whether thermally or otherwise, to remove microbes and their spores. An appropriately treated biomaterial that is appropriately hermetically sealed in a package will likely remain fit for ingestion or other use by a consumer for an extended period of time, assuming other appropriate storage conditions are implemented as necessary. Thus, the term “hermetically sealed package” or alternatively, the term “hermetically packaged” can be further defined as a package having a seal that keeps a biomaterial contained within the package fit for ingestion or other use by a consumer for an extended period of time.

By the term “sterilizing”, “sterilization”, and grammatical variants thereof, it is meant that the product is free of viable organisms or spores capable of growing under any conditions (can not be isolated and grown under optimum laboratory conditions.) In some embodiments a commercial sterile product is desired. By the term “commercially sterile” it is meant the condition achieved by application of heat, sufficient, alone or in combination with other ingredients and/or treatments to render the product free of microorganisms and/or spores capable of growing in the product at conditions at which the product is intended to be held during distribution and storage non-refrigerated, ambient temperatures. Commercially sterile products may have spores that could germinate and grow under some conditions but not storage conditions intended for the product. In no case would any spores that grow in the commercially sterile product be pathogenic.

By the term “thermal property”, it is meant any property of a flowable material (e.g., a biomaterial) that is related to the way the material (e.g., biomaterial) accepts or releases heat. Examples include, but are not limited to, thermal conductivity, or rate of heat penetration, rate of cooling, temperature, and combinations thereof. Representative thermal properties include rate of temperature changes, including rate of heat penetration and rate of cooling.

The methods of the presently disclosed subject matter can be employed in continuous flow treatment. As used herein, “continuous flow treatment” refers to methods in which a continuous stream of product is maintained in the treatment apparatus being used. Continuous flow thermal processing equipment can comprise heating, holding, and cooling sections, in which a continuous stream of product is maintained.

The equivalent point method can be used for evaluating thermal treatments be applied in practicing the presently disclosed subject matter when continuous flow treatment is used. This method describes the total thermal treatment received by a product in continuous flow equipment. Procedures for using the equivalent point method for analyzing the thermal effects on products during continuous flow heating have been previously outlined (Swartzel, 1982; Swartzel, 1986; U.S. Pat. No. 4,808,425) and are known to those skilled in the art.

In some embodiments, the presently disclosed subject matter involves microwave heating. The frequencies employed for microwave heating encompass the entire range classified as microwaves. Only four specific frequency bands are used for industrial heating applications in the United States. These four bands were allocated by the Federal Communications Commission and are called the Industrial-Scientific-Medical or ISM frequencies. These bands are at frequencies of 915 MHz, 2450 MHz, 5800 MHz, and 24,125 MHz. Users of industrial microwave equipment are permitted to generate unlimited power on these four bands, chosen so that they do not interfere with radar and communications. While the presently disclosed subject matter can incorporate the application of ISM frequency heating, the presently disclosed subject matter is not limited to these selected frequencies.

As used herein, the phrase “transparent to electromagnetic radiation” refers to a characteristic of a material whereby electromagnetic radiation (for example, radio frequencies or microwaves) substantially passes through the material. Similarly, the terms “radiolucent” and “microwave transparent” refer to material that is permeable to radio waves and microwaves, respectively. For example, the conduit carrying the biomaterial is manufactured of material that is radiolucent or microwave transparent. As used herein, the term “radiolucent” refers to a material that is essentially transparent to radio waves of the frequency used in the methods of the presently disclosed subject matter; while the material can be permeable to electromagnetic waves of other frequencies, this is not required. Similarly, the term “microwave transparent” refers to a material that is essentially transparent to microwaves. Examples of suitable radiolucent and/or microwave transparent materials include polytetrafluoroethylene (e.g., the products marketed as TEFLON® or HOSTAFLON™), and polycarbonate resins such as LEXAN®, or glass (e.g., KIMAX™ tempered glass process pipe), polypropylene, polymethylpentene (TPX™), polyetherimide (ULTEM™), polysulfone, PEEK etc. As would be apparent to one skilled in the art, the use of radiolucent and/or microwave transparent materials is required only to the extent necessary to allow sufficient exposure of the biomaterial.

In continuous flow apparatus used with methods of the presently disclosed subject matter, any device for establishing a continuous stream of flowable material (e.g., biomaterial) can be used to carry out the presently disclosed subject matter. An exemplary pump that can be used to establish the stream is a positive displacement pump, though a positive displacement pump (timing pumps) are generally needed to precisely define the holding time of a product stream in a holding section. Positive displacement pumps can be used in combination with other pumping devices, such as centrifugal pumps.

Upon a review of the present disclosure, it will be apparent to one skilled in the art that an adequate flow of flowable material through the apparatus must be produced so that the flowable materials are conveyed through the treatment apparatus at an adequate rate. Representative devices for producing a flow of flowable material (e.g., a biomaterial) include, but are not limited to, gravity flow conduits and pumps such as SINE PUMPS™ (Sine Pumps, Curacao, Netherlands Antilles), auger type pumps, piston type pumps, positive cavity displacement pumps (SEEPEX) or combinations thereof. Reversible thermal set carrier medium gels can also be used (e.g., methylcellulose solutions).

Using the methods and apparatuses of the presently disclosed subject matter, it is possible to treat biomaterials from temperatures below 40° F. (but above freezing) up to temperatures above 160° F., but below cooking temperatures. The product can then be held at the final temperature for a period of time adequate to destroy harmful and spoilage bacteria, as discussed below.

An optional preheating step can be employed prior to treatment to preheat the flowable material (e.g., biomaterial) to a temperature between about 120° F. and 155° F. Preheating systems can comprise, but are not limited to, conventional heating systems such as plate, swept, tube heat exchangers, ohmic systems, steam injection, hot water injection, hot fluid food injection, etc.

In some embodiments, the total thermal treatment received by a flowable material (e.g., a biomaterial) during the process must be sufficient to reduce the microbiological population in the product to an acceptable level. Proper thermal treatment can be facilitated by presetting the holding times. The term “holding time”, as used herein, has its ordinary meaning as used in the industry.

In some embodiments, the thermal treatment is sufficient to produce a product having a shelf life of about four weeks to about thirty-six weeks under ambient or refrigerated conditions, and in some embodiments a product having a shelf life of about eight weeks to about thirty-six weeks under ambient or refrigerated conditions. The term “refrigerated,” as used herein, means stored at or below a temperature of 4° C. but above freezing.

To produce uniformly treated flowable material (e.g., biomaterial), each unit of the flowable material (e.g., biomaterial) should receive substantially the same thermal treatment. This can be accomplished in accordance with the presently disclosed subject matter by exposing each unit of flowable material (e.g., biomaterial) to the same energy, with other conditions being substantially uniform.

Following thermal treatment the product can then be cooled using conventional cooling systems such as, but not limited to, plate heat exchangers, swept surface heat exchangers, liquid nitrogen injection, CO₂ gas injection or injection of other inert gases, or immersion in a water bath.

Elements of continuous flow apparatus which do not pass through the microwave exposure regions, are interconnected by a product line formed of any conventional sanitary material, such as stainless steel, TEFLON® or PVDF (KYNAR™) tubing.

To obtain a product with reduced quantities of microorganisms, the treatment apparatus can be sterilized before the biomaterial is passed there-through. Sterilizing can be accomplished by passing hot water under pressure through the treatment apparatus, as is known in the art, so that hot water is contacted to those surfaces which contact the product at a temperature and pressure and for a time sufficient to sterilize these surfaces. Any other method of sterilization of treatment apparatuses can also be used.

Unpackaged flowable material (e.g., biomaterial) can be aseptically packaged after treatment. “Aseptically packaged” means packaged to the exclusion of microorganisms other than those carried by the material itself, if any. Equipment suitable for aseptically packaging biomaterial, such as the COMBIBLOC 5™ and COMBIBLOC6™ (SIG, Switzerland) SealedAir (Charlotte, N.C., United States of America) FLAVOURMARK™, aseptic food cup fillers by Hassia (Germany), Bosch (Germany), large pouch, bag and tote fillers by Astepo (Italy), StarAsept (Liqui-Box USA, Richmond, Va., United States of America), JBT (Chicago, Ill., United States of America), as well as TETRA PAK™ TBA/9, the TETRA PAK™ TR7-ESL, the TETRA PAK™ Model AB-3-250 (all available from Tetra-Pak Inc., Vernon Hills, Ill., United States of America), and the Evergreen EQ-4 (Evergreen Packaging Equipment, Cedar Rapids, Iowa, United States of America), are commercially available. Also useful in carrying out this step is equipment which packages the product to the substantial exclusion of microorganisms, known in the industry as “clean fillers,” but the greater exclusion of microorganisms provided by aseptic fillers makes aseptic fillers preferable, particularly in view of the ability of Listeria and certain other microorganisms to grow under refrigerated conditions.

A homogenization step for unpackaged flowable biomaterial can optionally be included, but generally is not required. The term “homogenization” as used herein, means to subject a product to physical forces to reduce particle size. Such procedures are known in the art, and can be carried out on different types of equipment. In some embodiments, this homogenizing step is carried out with homogenizing equipment at total pressures of from about 500 pounds per square inch (p.s.i.) to about 3,000 p.s.i.

### VI. EXAMPLES

The following examples have been included to illustrate modes of the presently disclosed subject matter. In light of the present disclosure and the general level of skill in the art, those of skill will appreciate that the following examples are intended to be exemplary only and that numerous changes, modifications, and alterations can be employed without departing from the scope of the presently disclosed subject matter.

The following examples document the rationale and sequence of experimental trials used to test the functionality and feasibility of the presently disclosed subject matter. Application ranges of several different frequencies/wavelengths of microwave energy were considered. The dielectric properties of several hundred samples of different flowable foods were determined and a set of correlations for several food categories was established. Included were cheese and pasta sauces, puddings, formulas, beverages, vegetable purees and blends, soups and meals, and fruits and fruit purees. The theoretical basis for pursuing the current technology development based on combining multiple microwave oven/applicator devices into modular units to implement microwave heating of foods and biomaterials under continuous flow conditions and a range of temperatures appropriate for such treatments was evaluated as dependence of optimal diameter for a microwave transparent conduit for continuous flow microwave treatment of a variety of foods on the dielectric loss tangent, under three (3) most frequently applied microwave frequencies in household and industrial use. These frequencies were 460 MHz, 915 MHz (typical industrial microwave), and 2450 MHz (typical household microwave). Optimal diameter is a theoretical value which would allow uniform heating throughout the cylindrical flow profile assuming that the microwave energy is applied uniformly around the circumference of the cylinder and the food or biomaterial is flowing under a plug flow regime (all flow segments have an equal residence time).

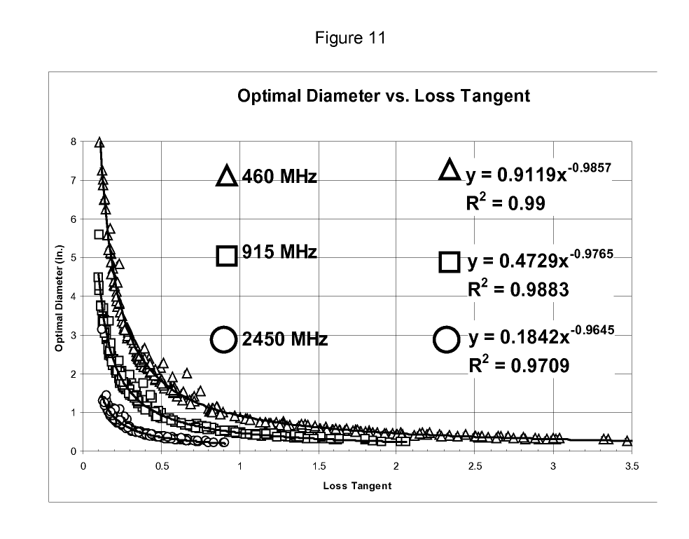

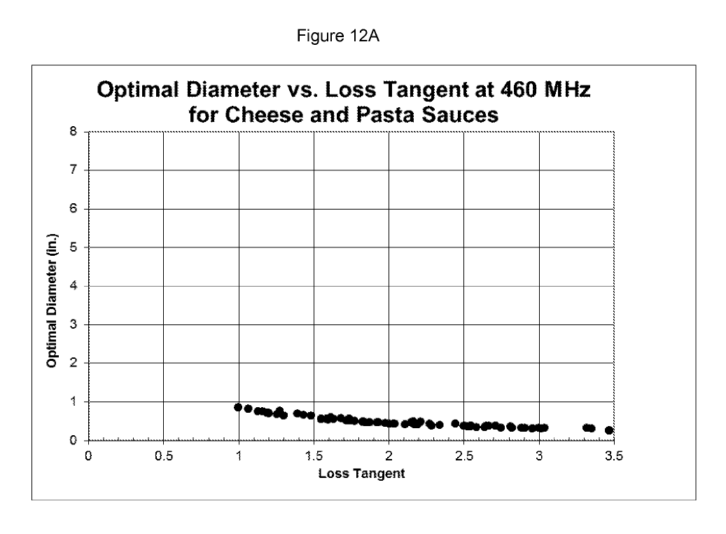

The graphs presented in FIGS. 11 and 12A-14E illustrate the theoretical basis for pursuing the presently claimed subject matter based on combining multiple microwave oven/applicator devices into modular units to implement microwave heating of foods and biomaterials under continuous flow conditions and a range of temperatures appropriate for such treatments.

Referring to FIG. 11, shown is the dependence of optimal diameter for a microwave-transparent conduit for continuous flow microwave treatment of a variety of foods on the dielectric loss tangent, under 3 most frequently applied microwave frequencies in household and industrial use.

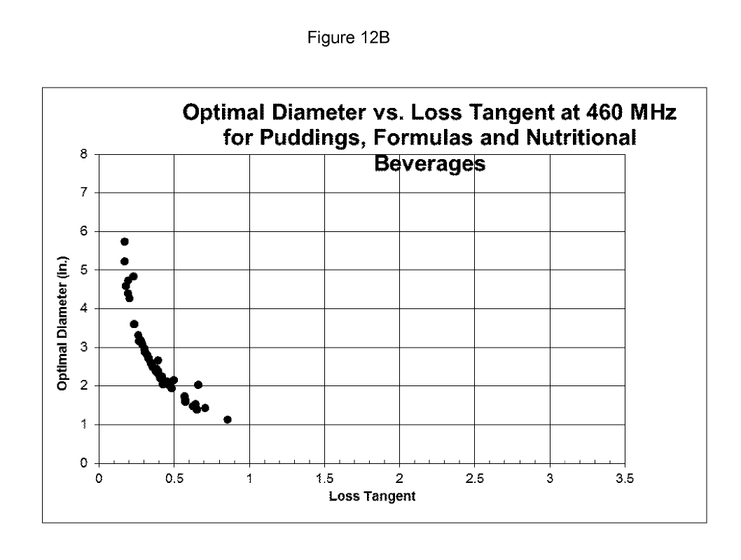

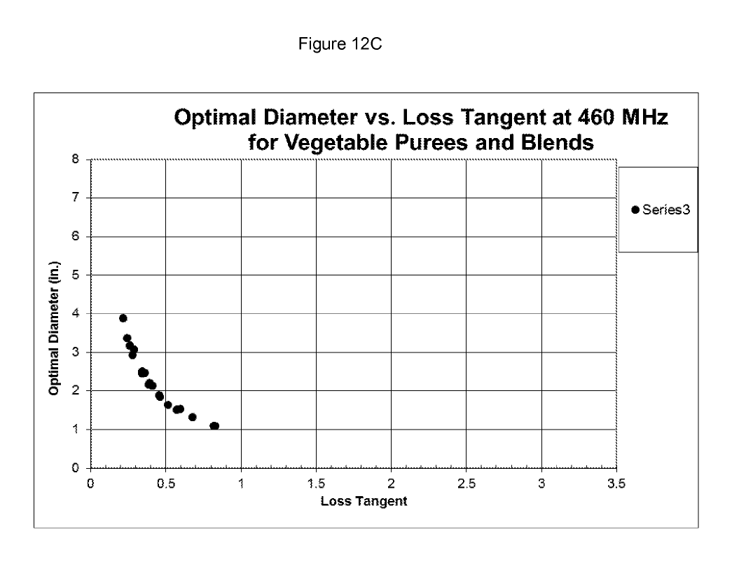

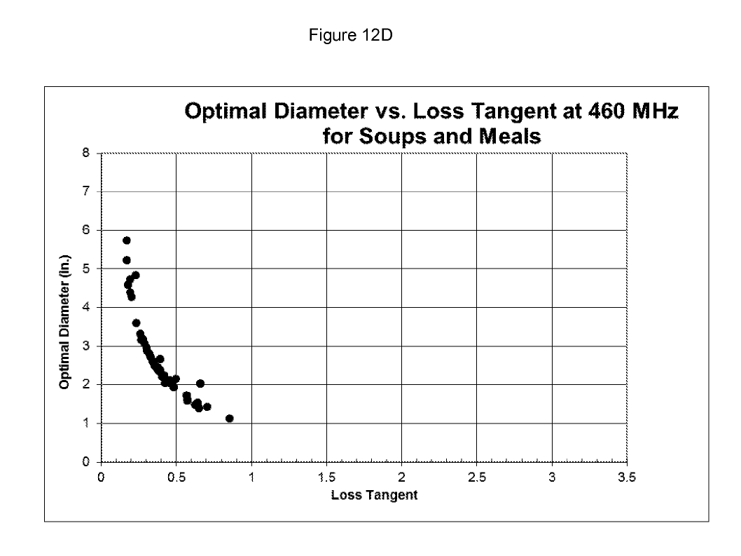

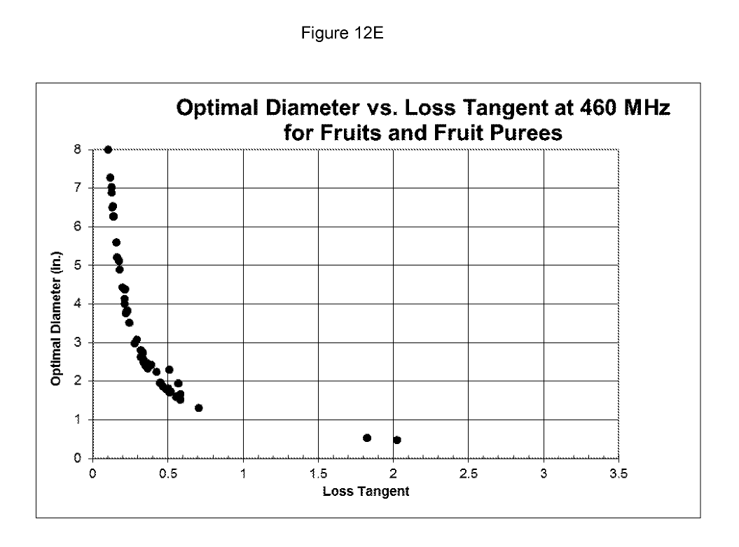

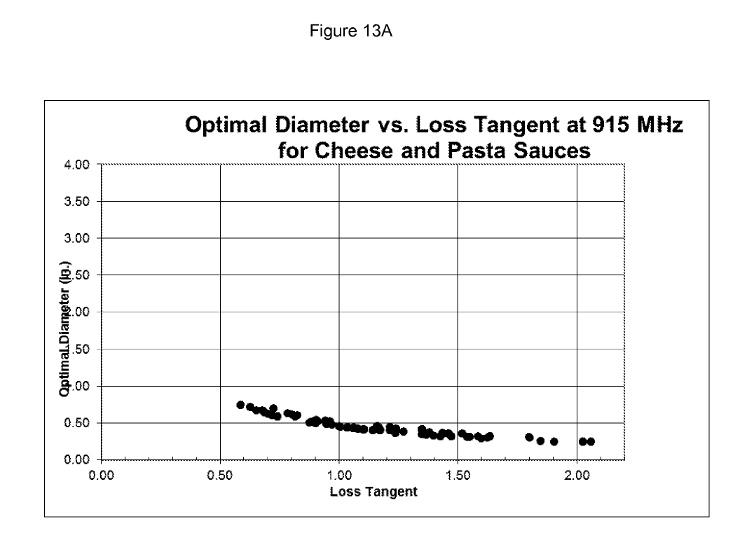

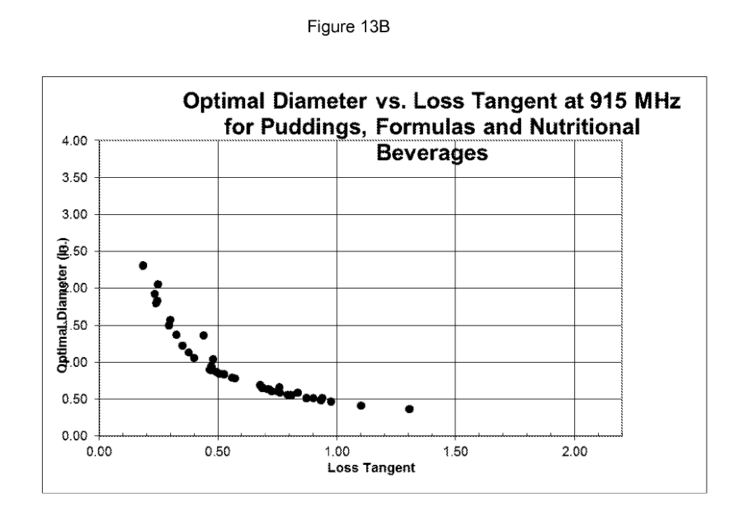

FIG. 12A provides an example for optimal diameters versus the measured dielectric loss tangent for one of the analyzed five (5) groups of flowable foods at a frequency of 460 MHz: Cheese and Pasta Sauces.

FIG. 12B provides an example for optimal diameters versus the measured dielectric loss tangent for one of the analyzed 5 groups of flowable foods at a frequency of 460 MHz: Puddings, Formulas and Nutritional Beverages.

FIG. 12C provides an example for optimal diameters versus the measured dielectric loss tangent for one of the analyzed 5 groups of flowable foods at a frequency of 460 MHz: Vegetable Purees and Blends.

FIG. 12D provides an example for optimal diameters versus the measured dielectric loss tangent for one of the analyzed 5 groups of flowable foods at a frequency of 460 MHz: Soups and Meals.

FIG. 12E provides an example for optimal diameters versus the measured dielectric loss tangent for one of the analyzed 5 groups of flowable foods at a frequency of 460 MHz: Fruits and Fruit Purees.

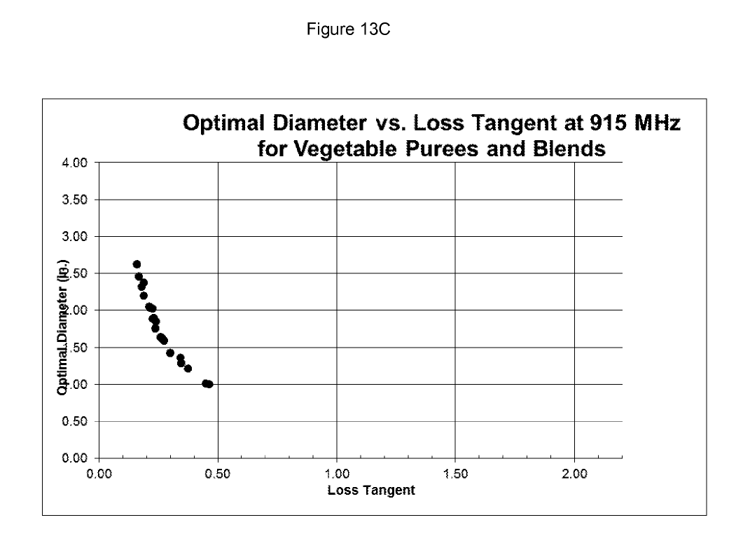

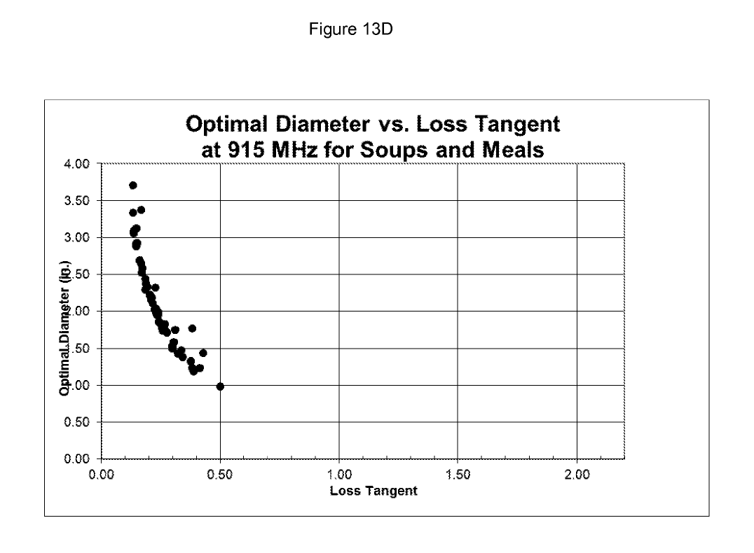

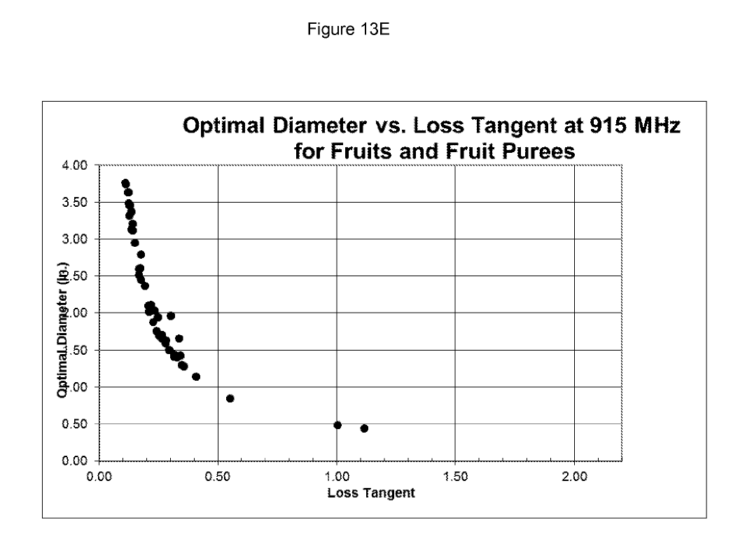

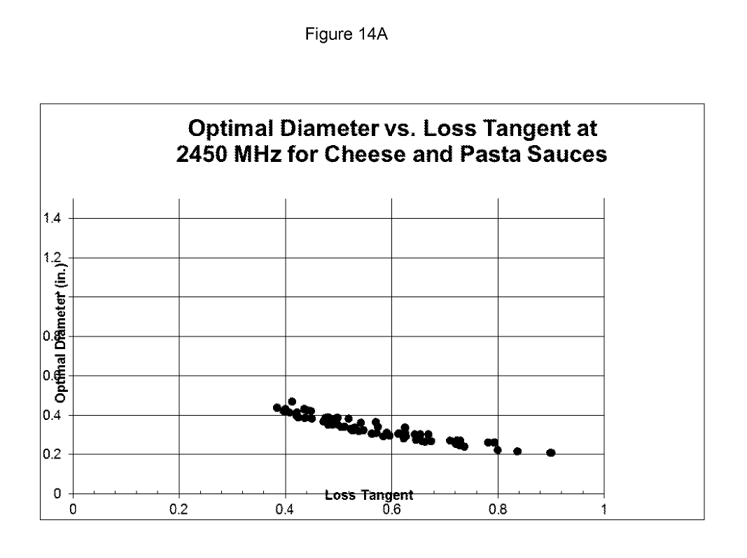

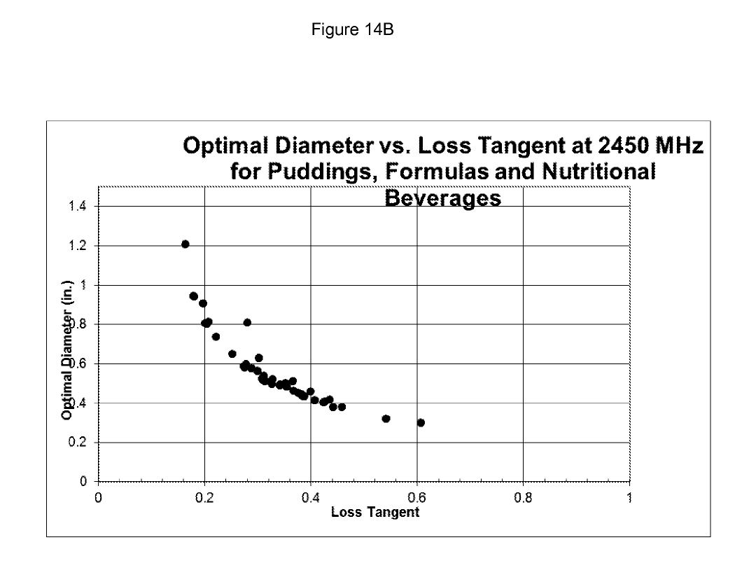

FIG. 13A provides an example for optimal diameters versus the measured dielectric loss tangent for one of the analyzed 5 groups of flowable foods at a frequency of 915 MHz: Cheese and Pasta Sauces.

FIG. 13B provides an example for optimal diameters versus the measured dielectric loss tangent for one of the analyzed 5 groups of flowable foods at a frequency of 915 MHz: Puddings, Formulas and Nutritional Beverages.

FIG. 13C provides an example for optimal diameters versus the measured dielectric loss tangent for one of the analyzed 5 groups of flowable foods at a frequency of 915 MHz: Vegetable Purees and Blends.

FIG. 13D provides an example for optimal diameters versus the measured dielectric loss tangent for one of the analyzed 5 groups of flowable foods at a frequency of 915 MHz: Soups and Meals.

FIG. 13E provides an example for optimal diameters versus the measured dielectric loss tangent for one of the analyzed 5 groups of flowable foods at a frequency of 915 MHz: Fruits and Fruit Purees.

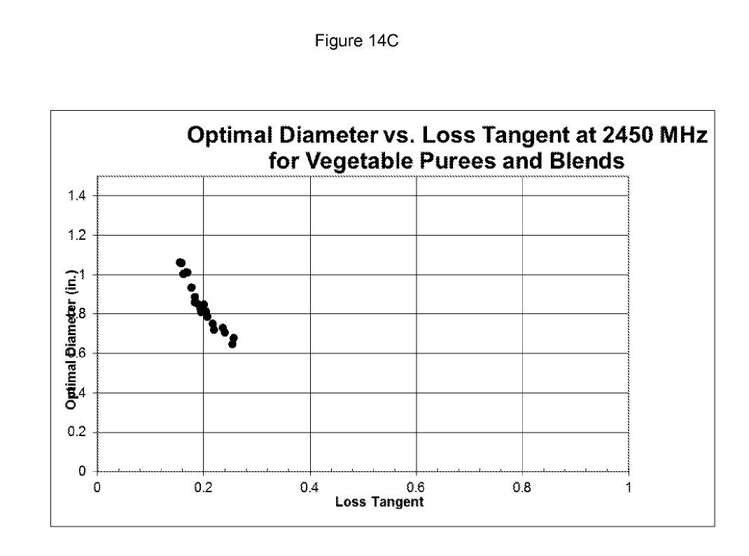

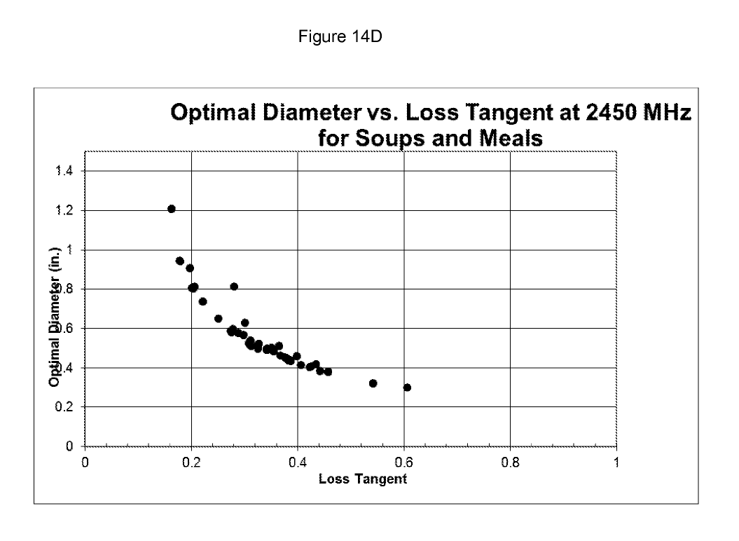

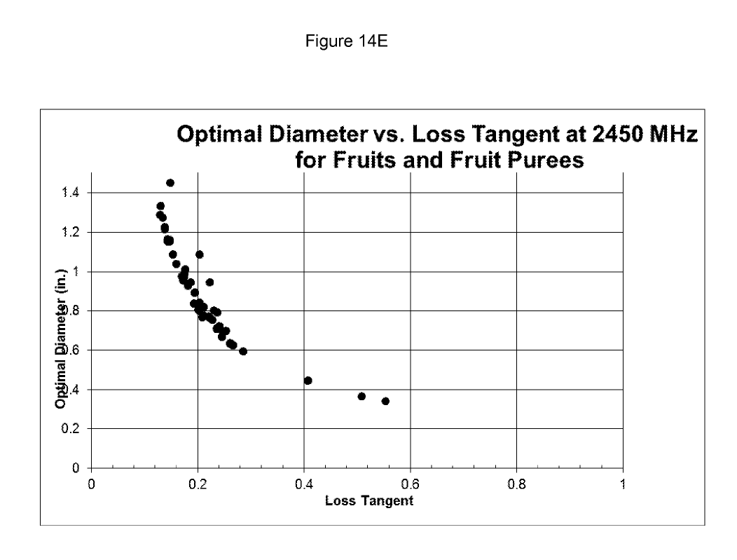

FIG. 14A provides an example for optimal diameters versus the measured dielectric loss tangent for one of the analyzed 5 groups of flowable foods at a frequency of 2450 MHz: Cheese and Pasta Sauces.

FIG. 14B provides an example for optimal diameters versus the measured dielectric loss tangent for one of the analyzed 5 groups of flowable foods at a frequency of 2450 MHz: Puddings, Formulas and Nutritional Beverages.

FIG. 14C provides an example for optimal diameters versus the measured dielectric loss tangent for one of the analyzed 5 groups of flowable foods at a frequency of 2450 MHz: Vegetable Purees and Blends.

FIG. 14D provides an example for optimal diameters versus the measured dielectric loss tangent for one of the analyzed 5 groups of flowable foods at a frequency of 2450 MHz: Soups and Meals.

FIG. 14E provides an example for optimal diameters versus the measured dielectric loss tangent for one of the analyzed 5 groups of flowable foods at a frequency of 2450 MHz: Fruits and Fruit Purees.

For continuous flow treatments of foods in the industry, typical tube diameters used range from about 1 inch to 4 inches.

Examination of the graphs described above illustrates the basis of the preference for 915 MHz for most of the tested materials. However, considering that the equipment cost for delivery of a kilowatt of energy is approximately an order of magnitude less expensive for the 2450 MHz devices compared to the 915 MHz devices, and that the energy density of the individual 1 kW units can be distributed over the length of the flow to take advantage of heat dissipation in the flowing materials to reduce the risk of localized overheating and tube failure, an effort to develop a continuous flow heating system based on multiple modular microwave units was supported and pursued.

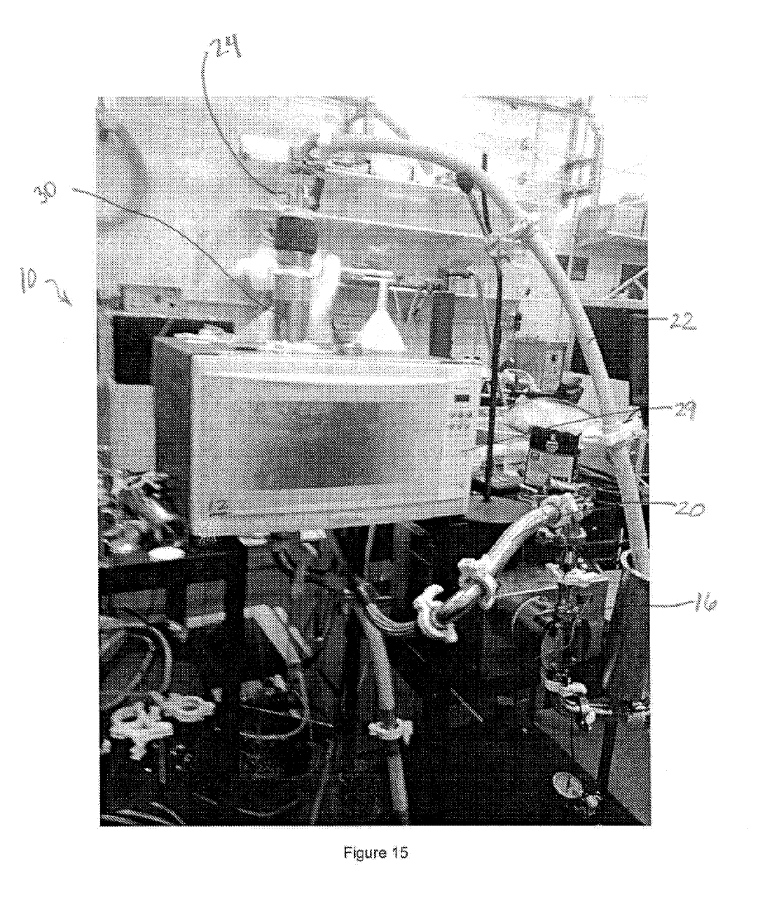

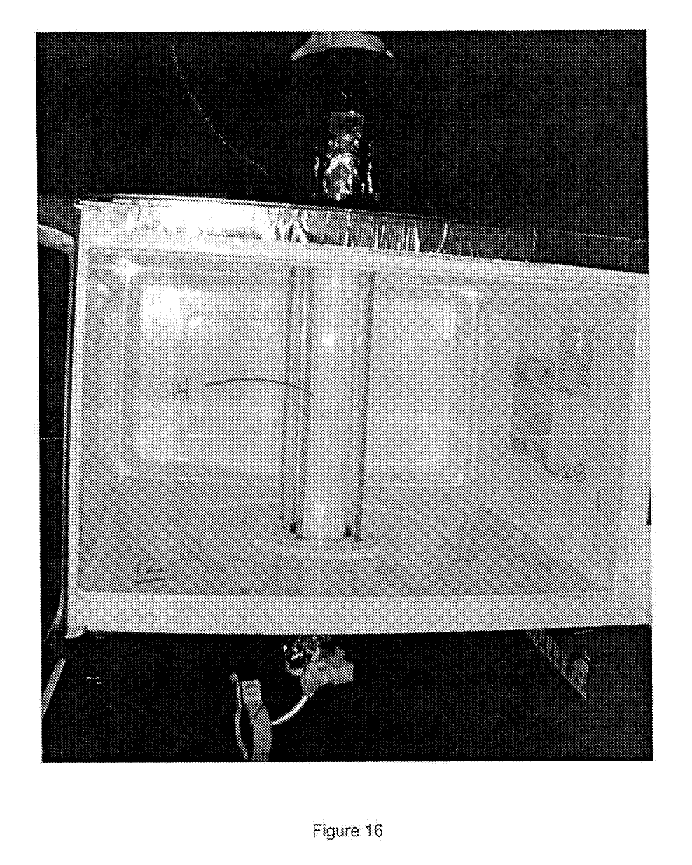

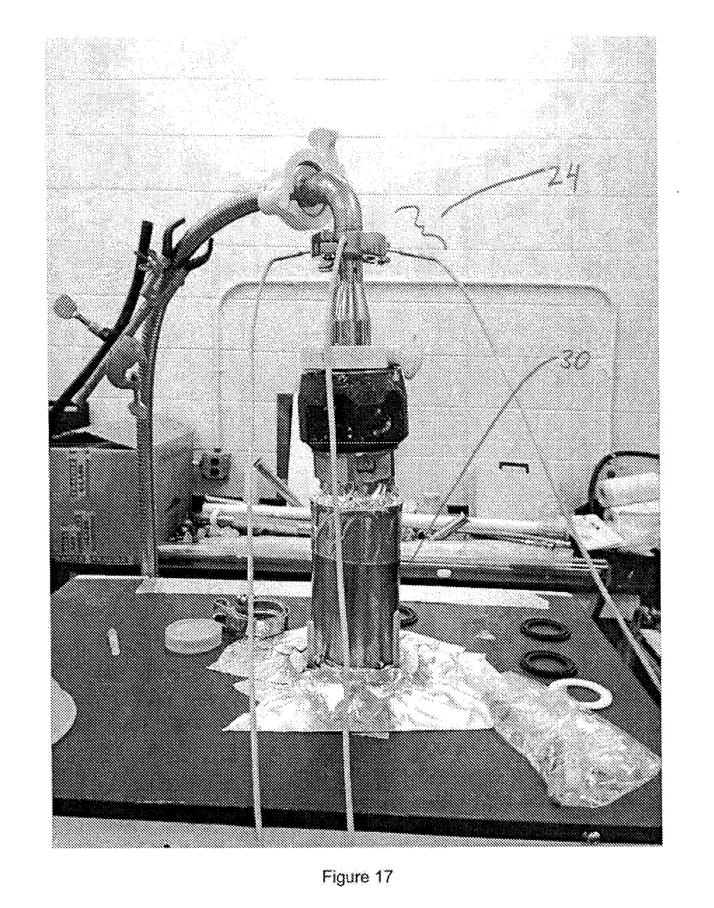

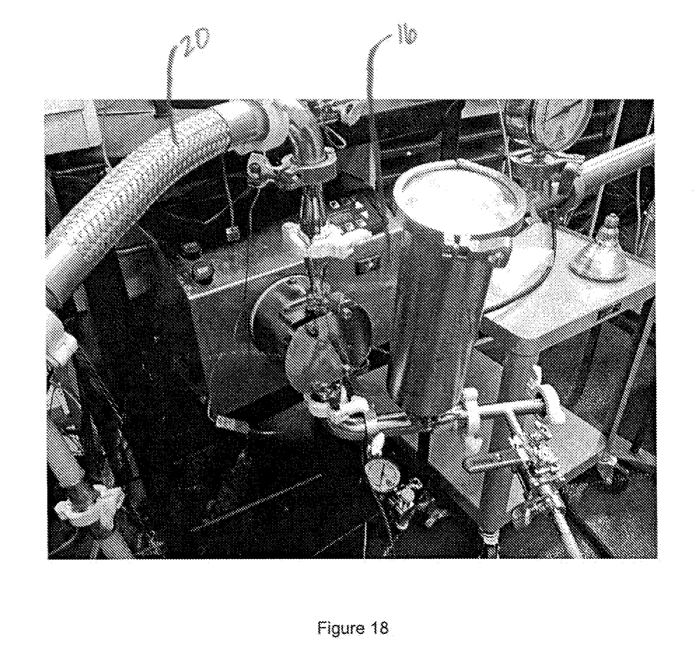

A first generation prototype comprising a single flow-through microwave cavity at 2450 MHz was extensively tested with a variety of flowable materials heated under recirculation to cover the anticipated range of temperatures of treatment to be encountered during processing. FIGS. 15-18 illustrate the first prototype of a single flow-through microwave heating system 10 constructed with the aim of testing the functionality and feasibility of using commercially available household 2450 MHz microwave ovens in series as components of modular systems in order to devise a method and equipment for treatment of foods and biomaterials. Referring particularly to FIG. 15, a first generation prototype of a continuous flow 2450 MHz microwave heating system 10 —single oven 12 is shown. Also shown is the installation with a pump 16 for recirculation and recirculation path for testing of temperature profiles achieved during continuous flow heating. Referring particularly to FIG. 16, shown is a first generation prototype of a continuous flow 2450 MHz microwave heating system 10—single oven 12, with internal microwave transparent flow-through conduit 14 comprising an internal TEFLON® tube encased in a cylindrical shell made of borosilicate glass. Referring to FIG. 17, shown is a close-up of the thermocouple temperature probe array 24 used to measure the cross sectional temperature profiles at the exit of the microwave cavity 12 in the first generation prototype of a continuous flow 2450 MHz microwave heating system 10—single oven 12. Referring to FIG. 18, shown is a close-up of the sanitary positive displacement pump 16 used for recirculation of the test material during the heating trials.

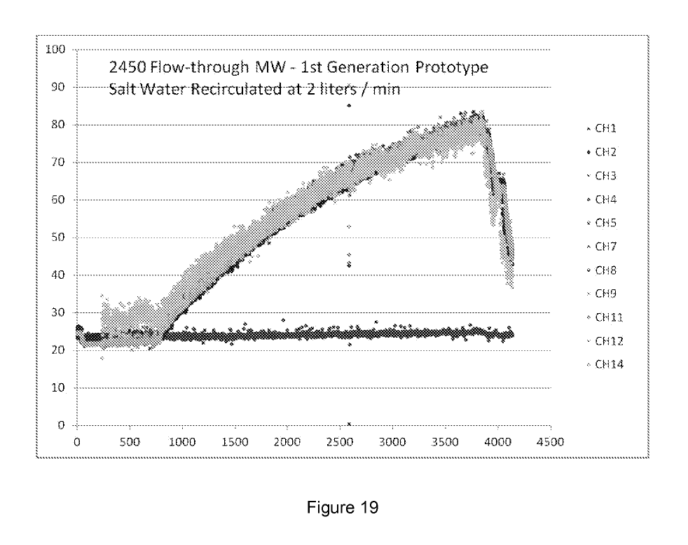

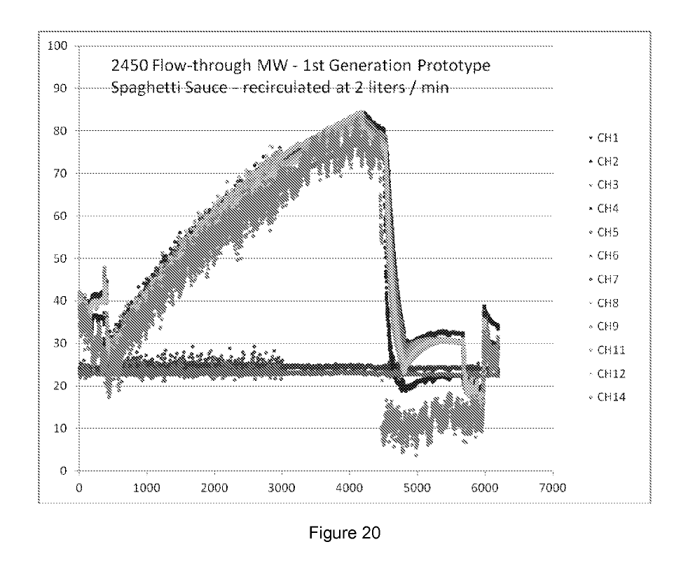

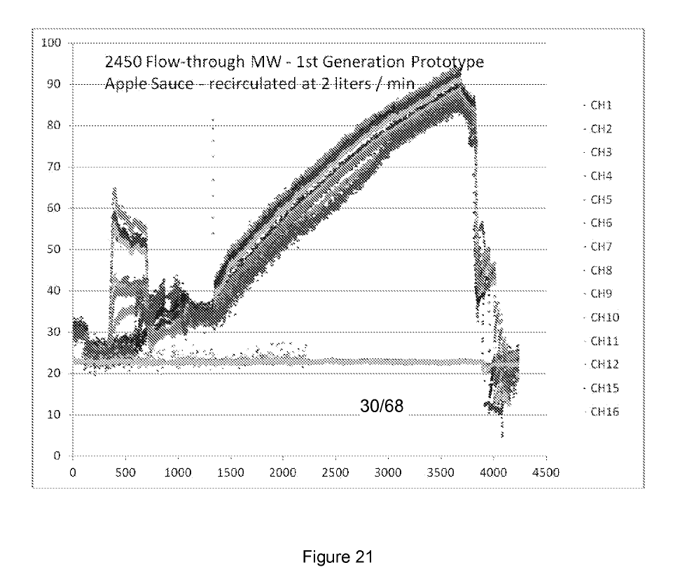

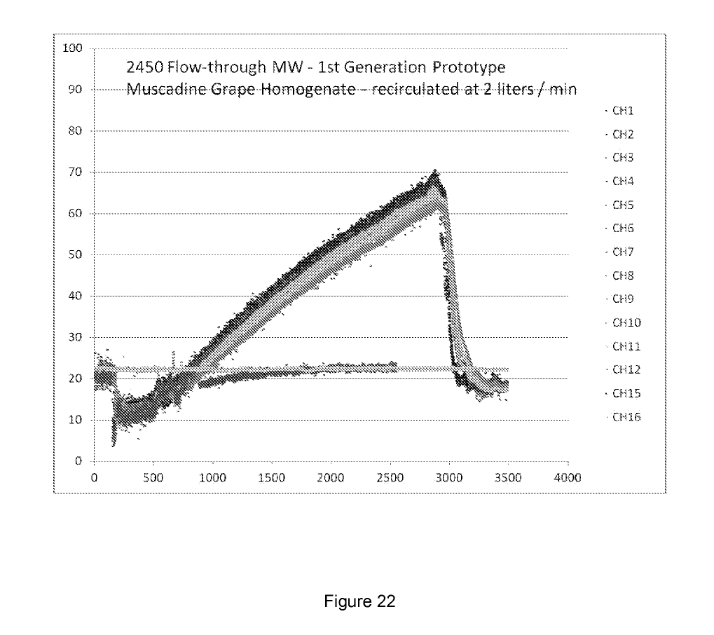

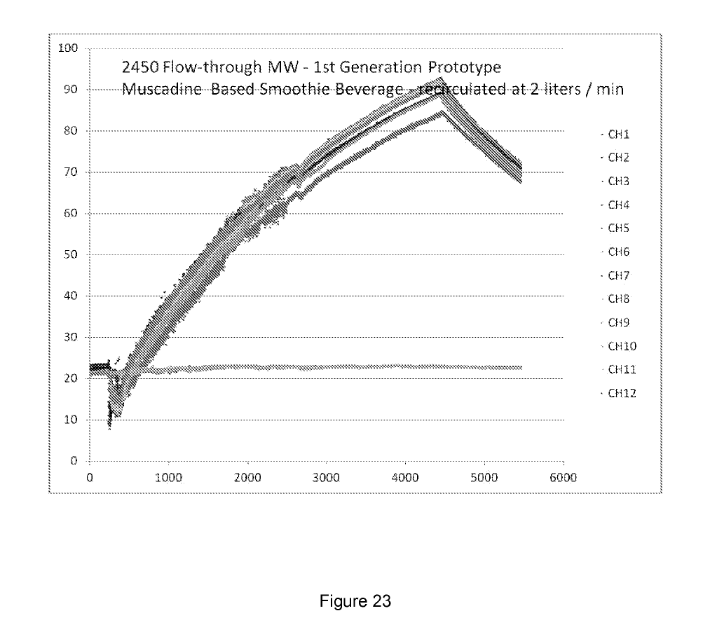

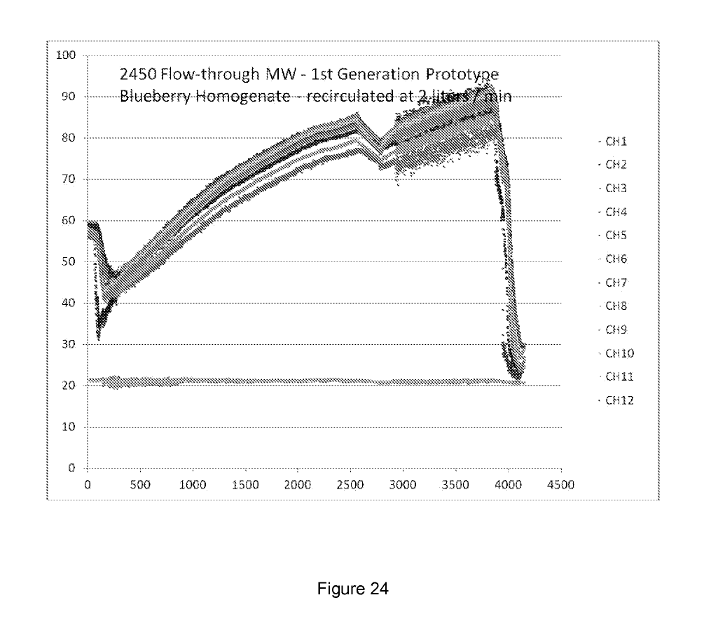

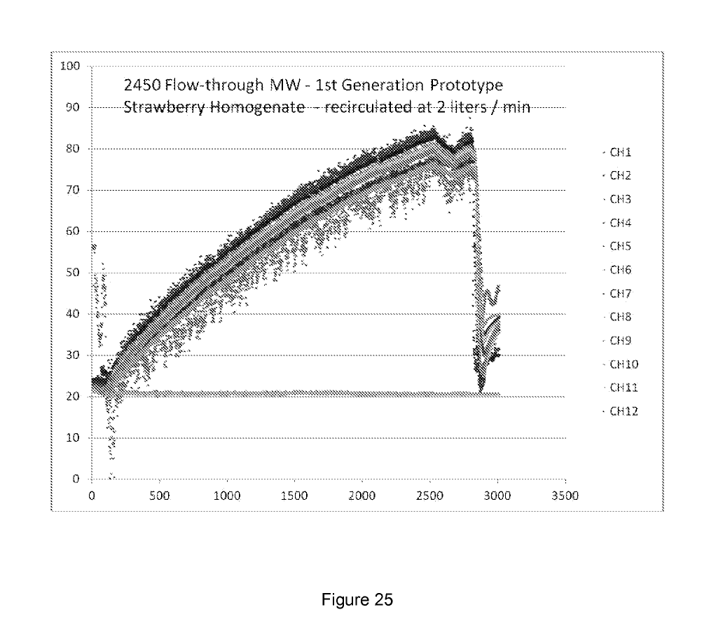

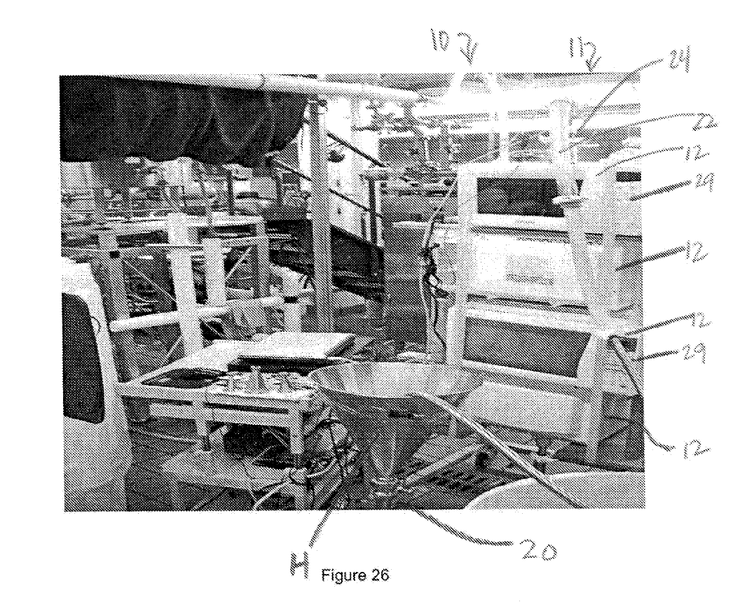

The first generation prototype system has been extensively tested with a variety of flowable materials heated under recirculation to cover the anticipated range of temperatures of treatment to be encountered during processing. The results of these trials are presented in FIG. 19 through FIG. 25:
FIG. 19. First generation prototype of a continuous flow 2450 MHz microwave heating device—single oven—recirculation testing with salted water at 2 liters per minute flow rate.
FIG. 20. First generation prototype of a continuous flow 2450 MHz microwave heating device—single oven—recirculation testing with spaghetti sauce at 2 liters per minute flow rate.
FIG. 21. First generation prototype of a continuous flow 2450 MHz microwave heating device—single oven—recirculation testing with apple sauce at 2 liters per minute flow rate.
FIG. 22. First generation prototype of a continuous flow 2450 MHz microwave heating device—single oven—recirculation testing with muscadine grape homogenate at 2 liters per minute flow rate.
FIG. 23. First generation prototype of a continuous flow 2450 MHz microwave heating device—single oven—recirculation testing with muscadine smoothie beverage at 2 liters per minute flow rate.
FIG. 24 First generation prototype of a continuous flow 2450 MHz microwave heating device—single oven—recirculation testing with blueberry homogenate at 2 liters per minute flow rate.
FIG. 25. First generation prototype of a continuous flow 2450 MHz microwave heating device—single oven—recirculation testing with strawberry homogenate at 2 liters per minute flow rate.

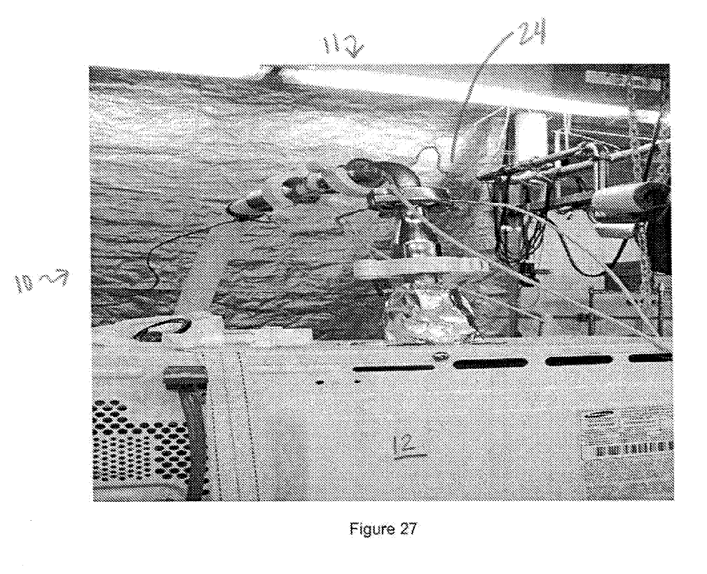

Upon confirmation of functionality and feasibility on a wide range of materials, a second generation prototype comprising four (4) microwave cavities at 2450 MHz in series was also constructed, illustrated by FIGS. 26 and 27, and tested under recirculation heating. Referring to FIG. 26, a second generation prototype of a continuous flow 2450 MHz microwave heating system 10 comprises four ovens/cavities 12 in series, hopper H that feeds a pump (not visible in FIG. 26), tubing 20 and 22, and temperature data acquisition component 24. System 10 is employed during recirculation testing. Referring to FIG. 27, shown is a close up of the outlet of the top microwave oven/cavity 12 with the thermocouple temperature measurement array component 24 installed to measure the cross sectional temperature distribution at the outlet of the set or module 11 of the second generation prototype of a continuous flow 2450 MHz microwave heating device—four ovens in series—system 10.

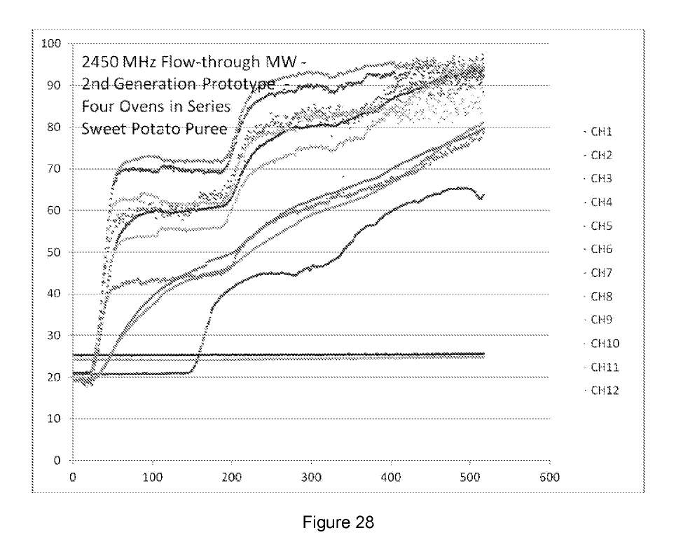

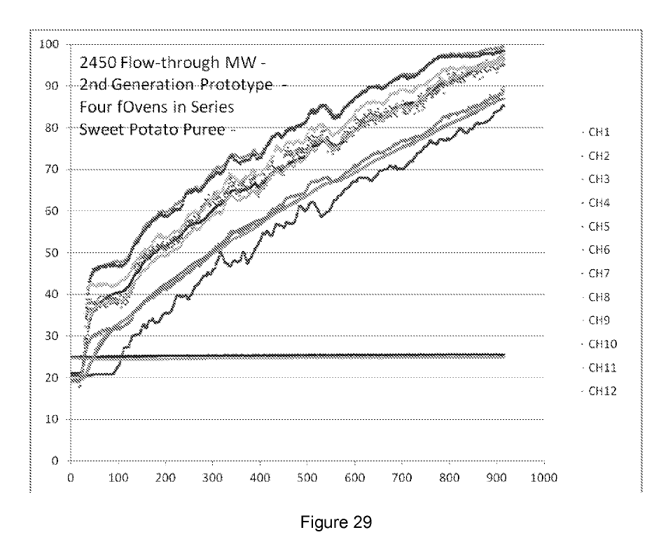

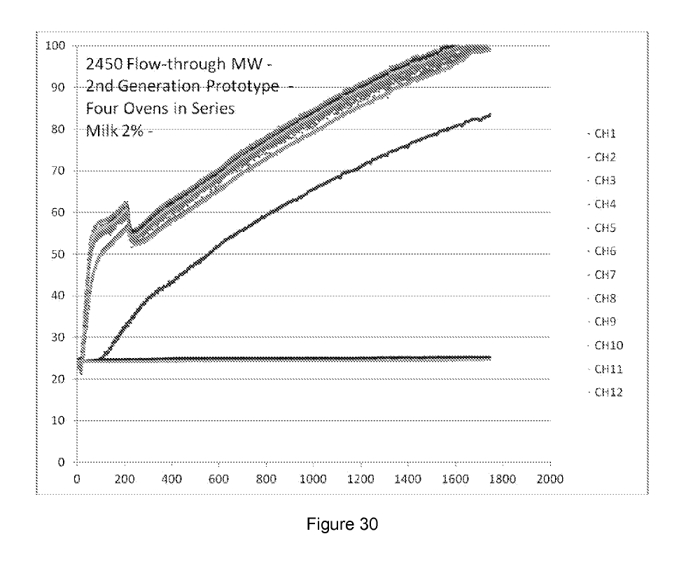

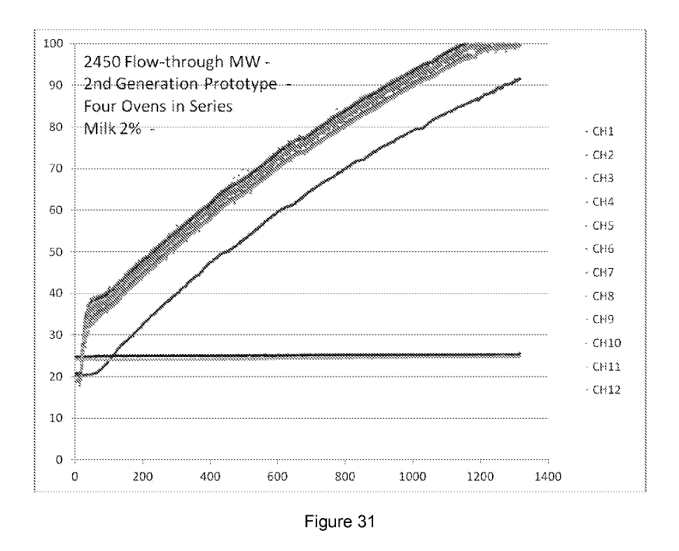

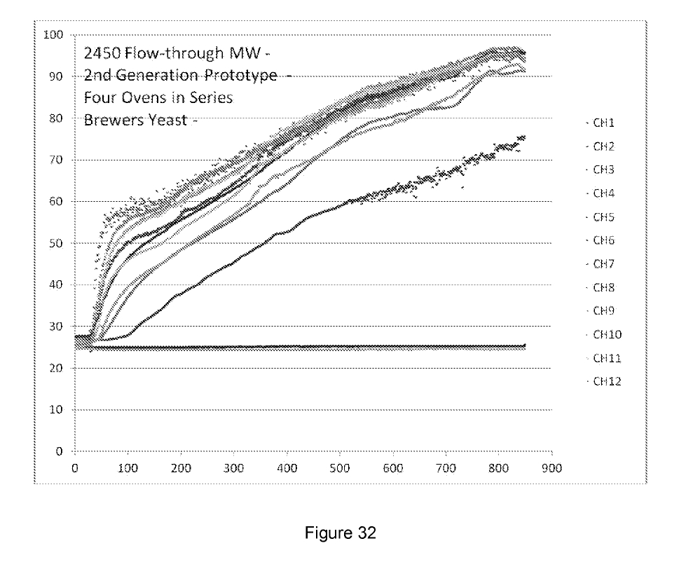

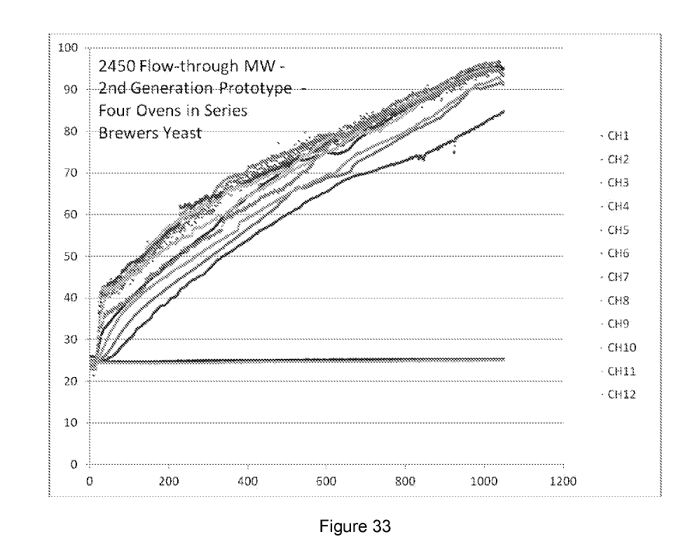

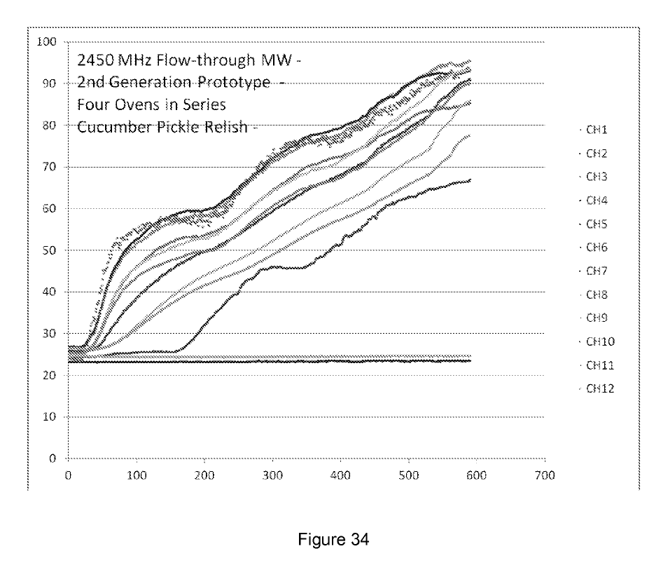

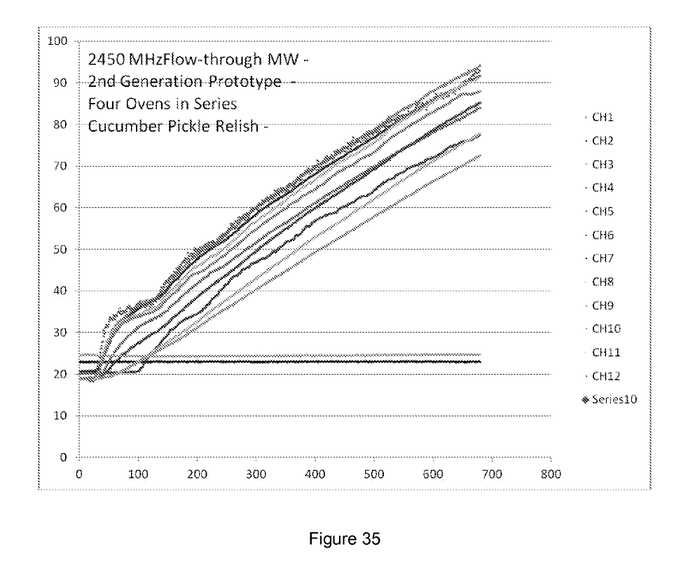

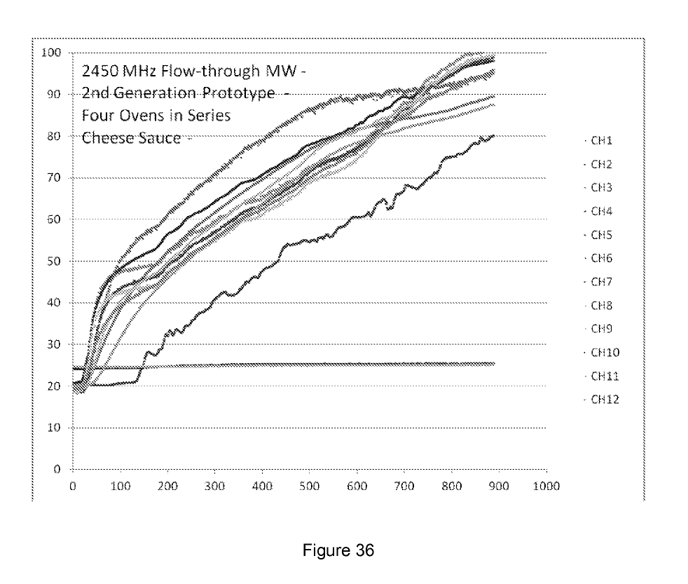

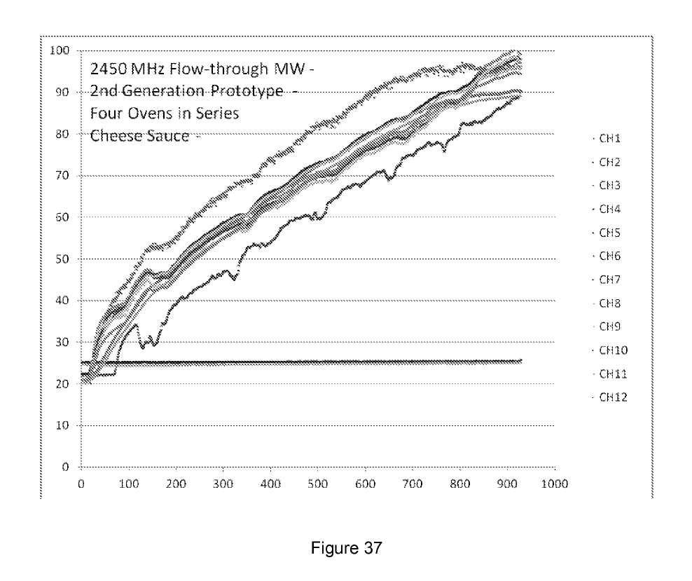

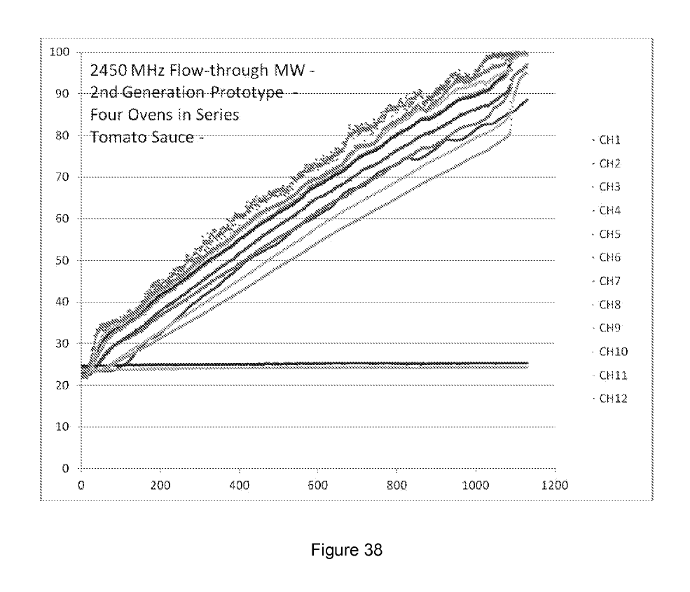

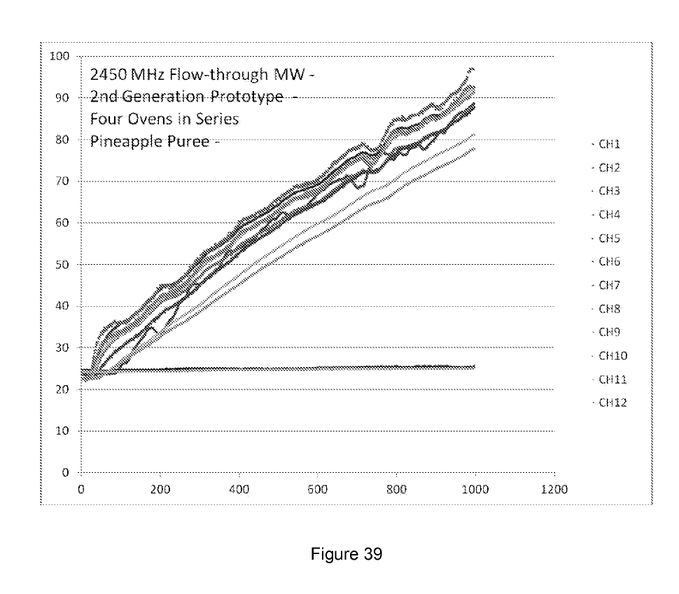

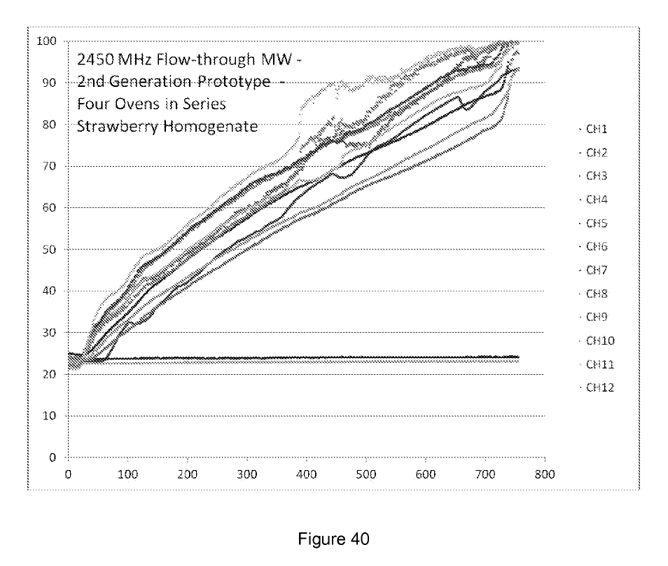

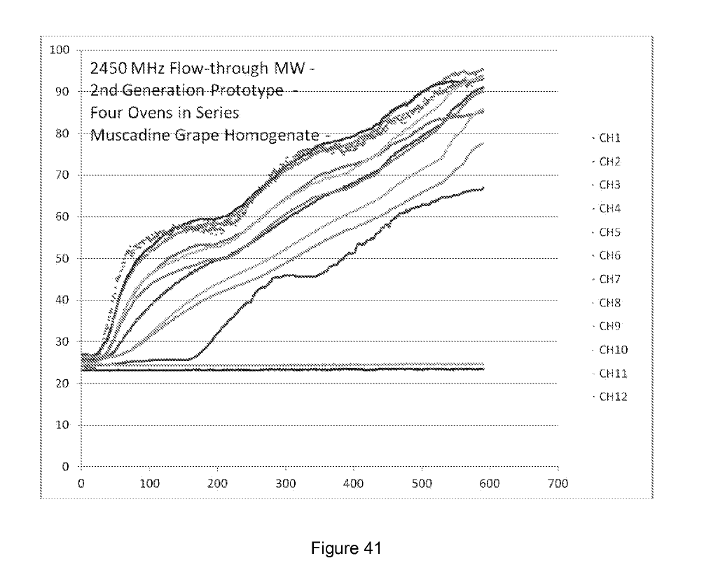

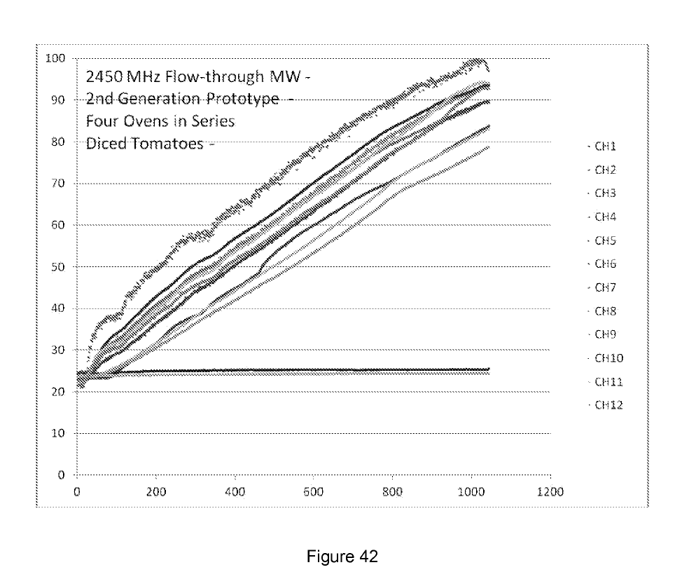

The results of the recirculation heating trials of the second generation prototype are presented in FIGS. 28 through 42:
FIG. 28. Second generation prototype of a continuous flow 2450 MHz microwave heating device—four ovens in series—recirculation testing with sweet potato puree at 1 liter per minute flow rate.
FIG. 29. Second generation prototype of a continuous flow 2450 MHz microwave heating device—four ovens in series—recirculation testing with sweet potato puree at 2 liters per minute flow rate.
FIG. 30. Second generation prototype of a continuous flow 2450 MHz microwave heating device—four ovens in series—recirculation testing with 2% milk at 1 liter per minute flow rate.
FIG. 31. Second generation prototype of a continuous flow 2450 MHz microwave heating device—four ovens in series—recirculation testing with 2% milk at 2 liters per minute flow rate.
FIG. 32. Second generation prototype of a continuous flow 2450 MHz microwave heating device—four ovens in series—recirculation testing with brewers yeast precipitate at 1 liter per minute flow rate.
FIG. 33. Second generation prototype of a continuous flow 2450 MHz microwave heating device—four ovens in series—recirculation testing with brewers yeast precipitate at 2 liters per minute flow rate.
FIG. 34. Second generation prototype of a continuous flow 2450 MHz microwave heating device—four ovens in series—recirculation testing with cucumber pickle relish at 1 liter per minute flow rate.
FIG. 35. Second generation prototype of a continuous flow 2450 MHz microwave heating device—four ovens in series—recirculation testing with cucumber pickle relish at 2 liters per minute flow rate.
FIG. 36. Second generation prototype of a continuous flow 2450 MHz microwave heating device—four ovens in series—recirculation testing with cheese sauce at 1 liters per minute flow rate.
FIG. 37. Second generation prototype of a continuous flow 2450 MHz microwave heating device—four ovens in series—recirculation testing with cheese sauce at 2 liters per minute flow rate.
FIG. 38. Second generation prototype of a continuous flow 2450 MHz microwave heating device—four ovens in series—recirculation testing with tomato sauce at 2 liters per minute flow rate.
FIG. 39. Second generation prototype of a continuous flow 2450 MHz microwave heating device—four ovens in series—recirculation testing with pineapple puree at 2 liters per minute flow rate.
FIG. 40. Second generation prototype of a continuous flow 2450 MHz microwave heating device—four ovens in series—recirculation testing with strawberry homogenate at 2 liters per minute flow rate.
FIG. 41. Second generation prototype of a continuous flow 2450 MHz microwave heating device—four ovens in series—recirculation testing with muscadine grape homogenate at 2 liters per minute flow rate.
FIG. 42. Second generation prototype of a continuous flow 2450 MHz microwave heating device—four ovens in series—recirculation testing with diced tomatoes in tomato juice at 2 liters per minute flow rate.
   The results of the recirculation heating trials confirmed the validity of the approach using modular sets of multiple commercially available microwave ovens in series.

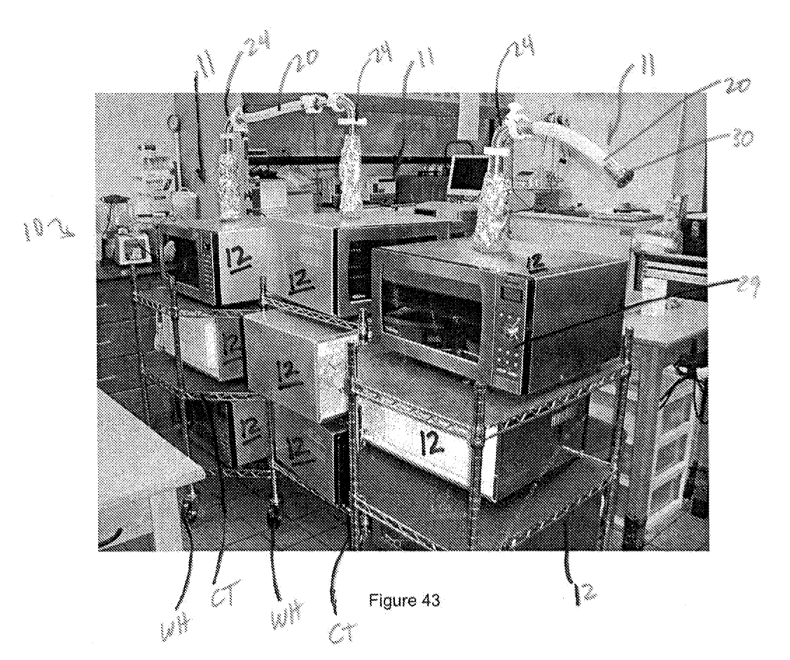

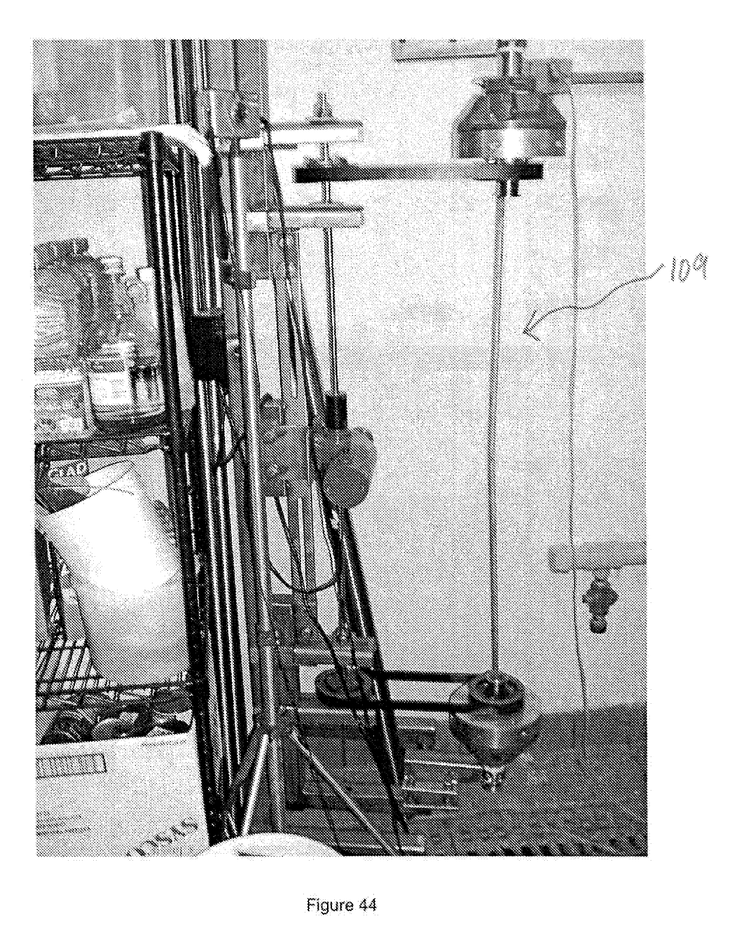

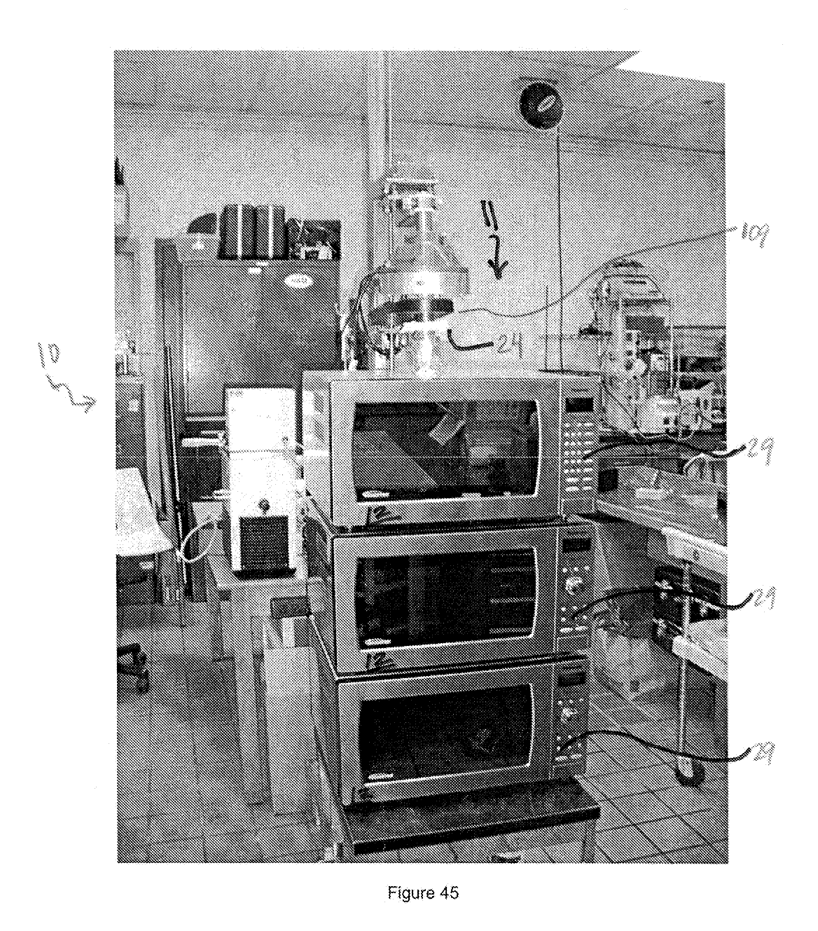

This was followed by the construction of multi-modular continuous flow heating systems. Referring to FIGS. 43-45, a mobile third generation prototype system 10 comprising three modules 11 comprising three (3) microwave cavities 12 each, at 2450 MHz, on carts CT with wheels WH and a fourth generation prototype system 10 integrating an inline active mixing device 109 as described in FIGS. 10B-10D with a vertical module 11 comprise three (3) microwave cavities 12 at 2450 MHz. In some embodiments, non-agitated modules are used in the early stages of multi-modular heating installations, where the temperatures are relatively low, while the agitated modules are be used as the last stage of multi-modular heating to facilitate the uniformity of temperature distribution and reduce the risk of deposit formation on the food contact walls of the microwave-transparent conduits.

In some embodiments, the presently disclosed subject matter includes four connected microwave processing modules, each containing four or five individual 2450 MHz microwave units. The modules are enclosed in individual stainless steel enclosures ensuring full sanitary construction but also enabling easy access, cleaning, mobility, transport, connectivity and integration into variously configured processing systems. The combined modules are assembled to enable processing and packaging of a wide range of flowable food materials. Testing focuses on novel, difficult to process materials, which have been, due to their thermo-physical properties limited to other conventional and/or outdated methods of preservation such as hot-filling and canning.

A representative product range includes several groups of products to provide an appropriate representation of the broad range of products compatible with the methods and systems of the presently disclosed subject matter: apple cider; cucumber and sweet pepper relishes; soy and barbecue sauces; berry homogenates; and ground seasoned meat sauces (spaghetti, chili and/or taco sauces). The assembled modular system conducts two tests of run time extension—one at 4 hours of continuous operation and another at 8 hours of continuous operation. For each test run, the targeted thermal process is designed and implemented, while monitoring the achieved temperature profiles at the exit of each module and temperature differences delivered during heating at different ranges of treatment. Each product is processed, aseptically packaged and stored for further flavor, nutrient and shelf life/stability testing. In some embodiments this sequence establishes the operational parameters as well as provides samples.

In order to further demonstrate the functionality of the modular systems and feasibility for processing of difficult and poorly conductive food materials, in this example pork liver and meat based pate was selected as the material to be processed. The following example illustrates the system used, preparation, power control for individual microwave units within the finishing multi-microwave modules, temperature recording at various process locations, and collection of the finished pasteurized product.

The modular microwave units have been assembled, connected to computers and coupled in order to control the individual units using a micro-controller devices (available from Arduino, Sommerville, Mass., United States of America) to control multiple units in each vertical multi-microwave module. Four vertical multi-MW modules have been used in the system:

Module 1: Four benchtop MW units, 1250 Watts power each

Module 2: Four benchtop MW units, 1250 Watts power each

Module 3: Five benchtop MW units, 1250 Watts power each

Module 4: Five benchtop MW units, 1250 Watts power each

The pate product was precooked in a steam-jacketed kettle, loaded into a meat paste pump connected using stainless steel connectors and braid reinforced flexible sanitary tubing to the microwave modules which have been fitted with TEFLON® tubes with 1.5 inch standard tri-clover sanitary stainless steel connectors at the top and the bottom. The pate was then pumped using the meat past pump through the sequence of modules as outlined above.

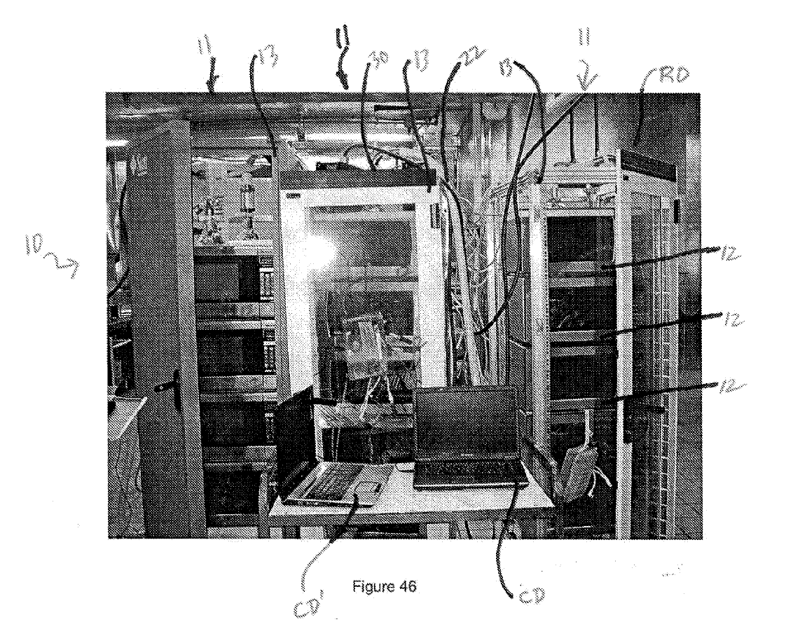

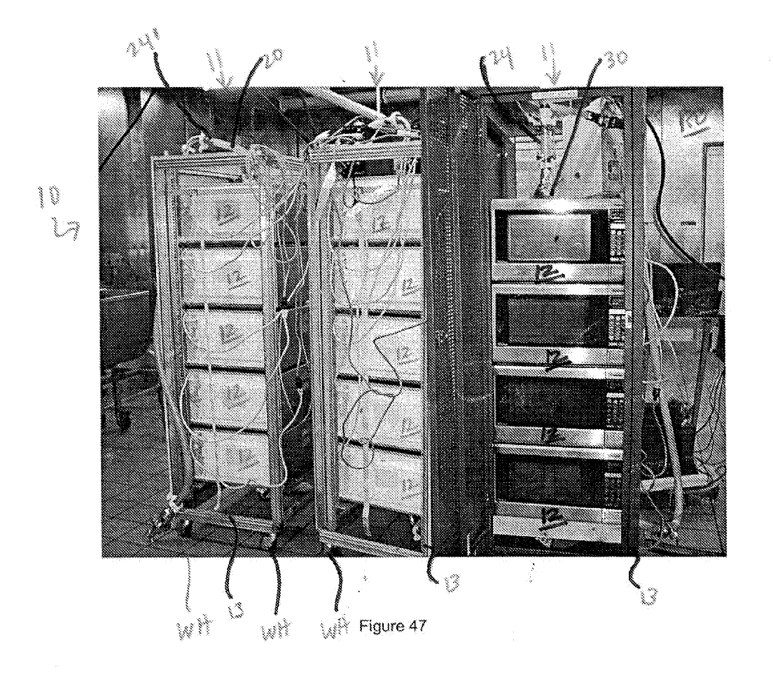

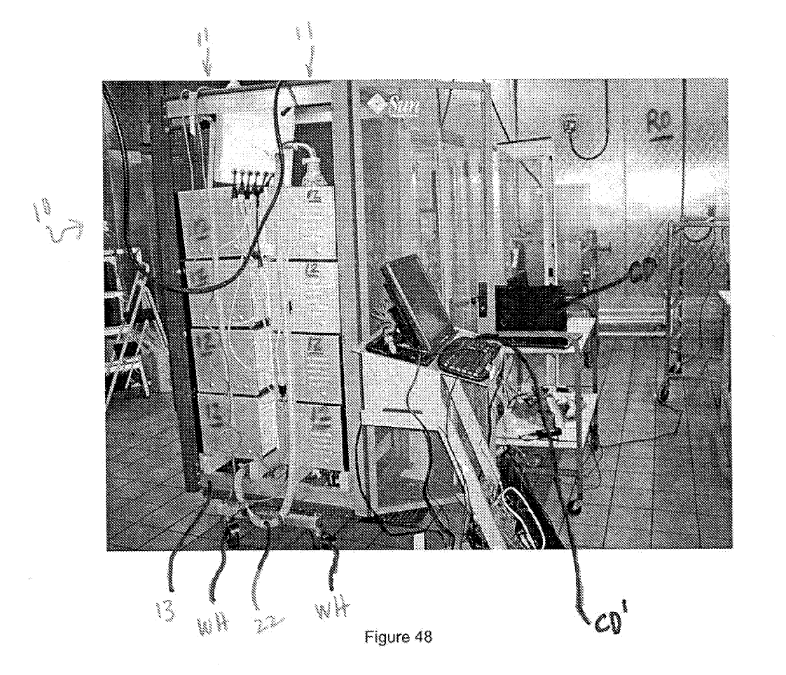

Referring now to FIGS. 46-55, shown are four vertical modules 11 used in the system 10 in processing room RO. Two of the modules with 4 MW units 12 each have been placed in one vertical cabinet 13, while each of the other two 5 MW unit modules 11 had its own cabinet 13 and wheels WH (best seen in FIGS. 47 and 48). This is also visible in FIG. 47, which provides a view from the back of the modules 11 used, as well as in FIG. 48, displaying the side view, and the arrangement of the two 4 unit modules 11 placed in the first cabinet 13 on the left in FIG. 46 and on the right in FIG. 47. Process material PR initially enters the first module 11 (on the right in cabinet 13) from the bottom, is conveyed to the top and transported via the high temperature mesh-enforced silicone tubing 22 to the bottom of the second 4 unit module 11, exits at the top and enters the third (5 unit) module 11 at the bottom, exits at its top to be conveyed and enter the 4^{th} and final (5 unit) module 11. Then, process material PR is pumped and heated through the stack of 5 microwave units 12 to the top and collected into polypropylene pails 26 to be cooled and packaged.

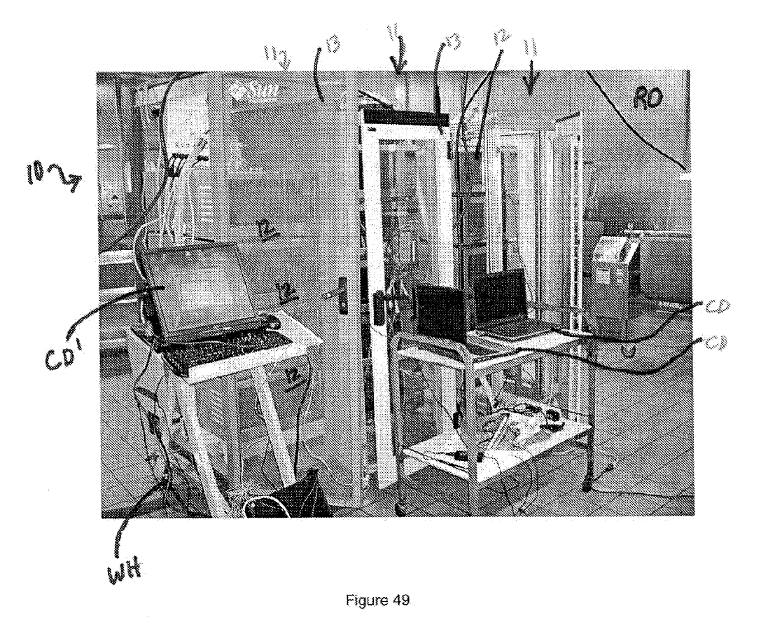

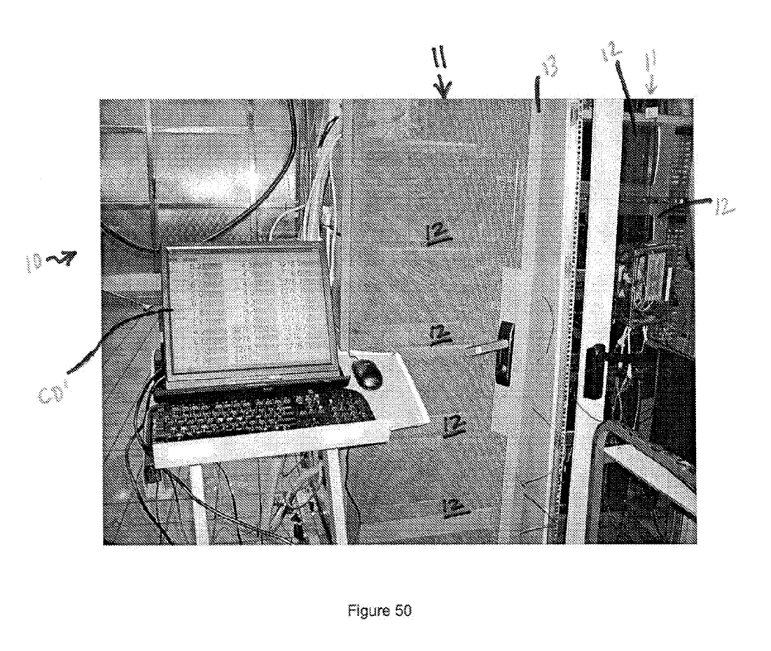

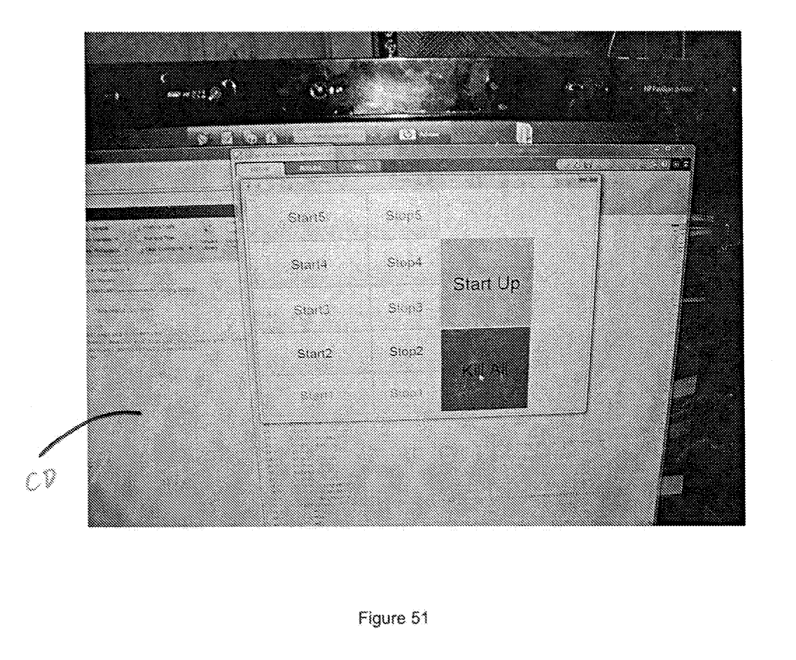

FIG. 49 illustrates the arrangement for the control of two 5 unit modules 11, with two laptop computers CD each connected to the MW controls using an Arduino microcontroller, and another laptop computer CD′ on the left of the figure used to display, monitor and record temperatures at desired points in the continuous flow system—e.g., entry and exit of each module/heating stage. The two laptop computers CD (one for each of the two 5 unit modules) are used to control (power on and off) the individual MW units contained in each of the two final stages/modules for processing. FIG. 50 shows the close up of the temperature measurement and recording display on the laptop computer CD′ pictured on the left in FIG. 49, thus providing computer data acquisition for monitoring, display and recording of temperatures at different locations in the flow-through tubing—such as at entry and exit points of each individual module 11. FIG. 51 displays the control command panel on laptop computers CD used to control each of the 5 MW unit modules on the right hand side of the system arrangement as shown in FIGS. 46-55. In FIG. 51, a close-up of the computer display used for real-time control of individual MW units 12 (not seen in FIG. 51) within each multi-unit module 11 (not seen in FIG. 51) can be seen. Controls can be triggered either via a mouse click or touch-screen based commands, for example.

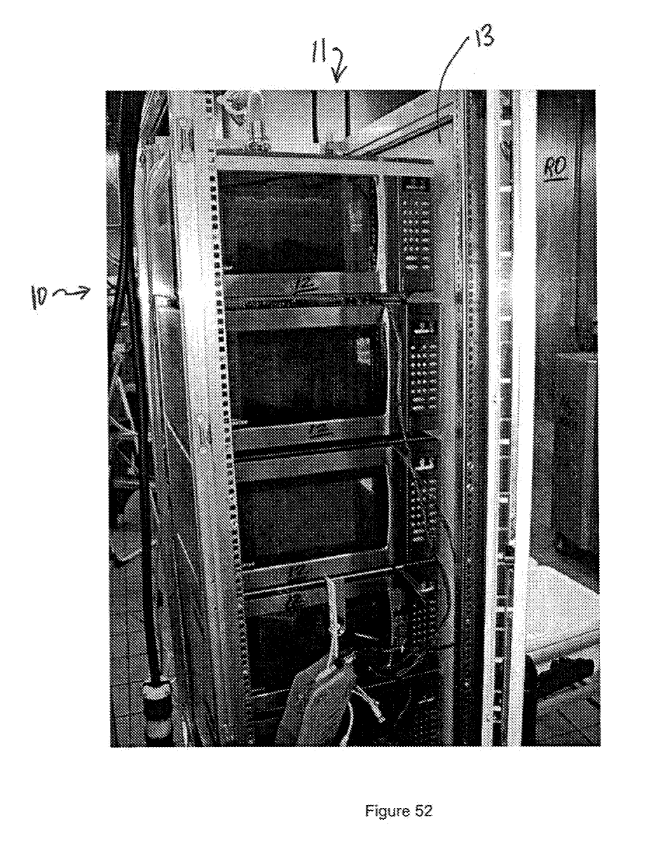

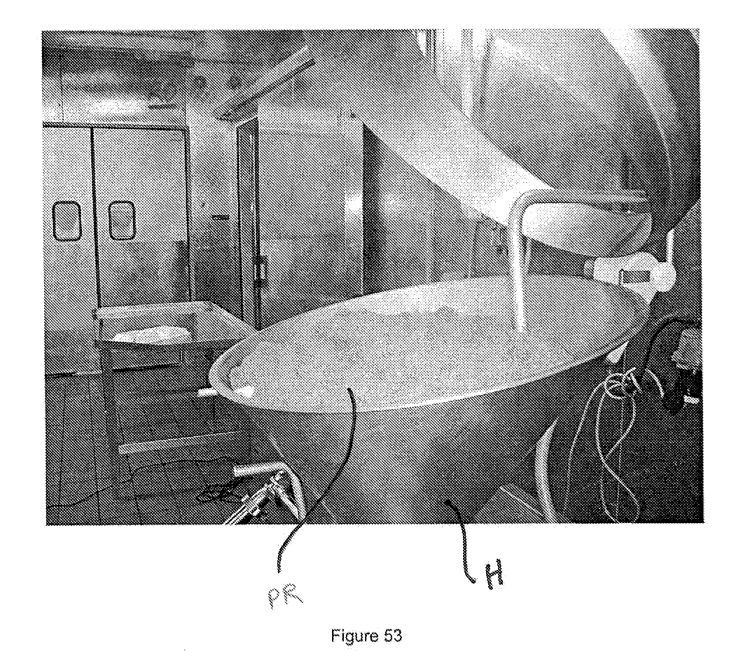

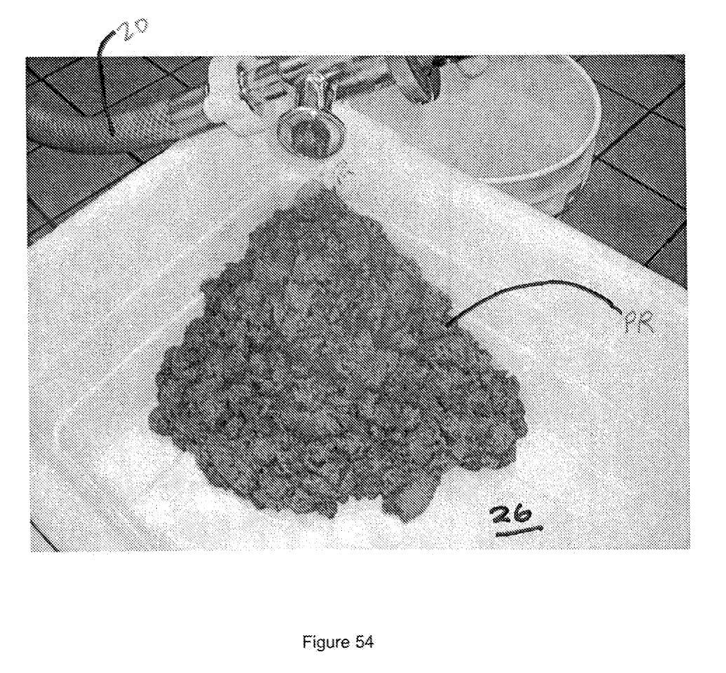

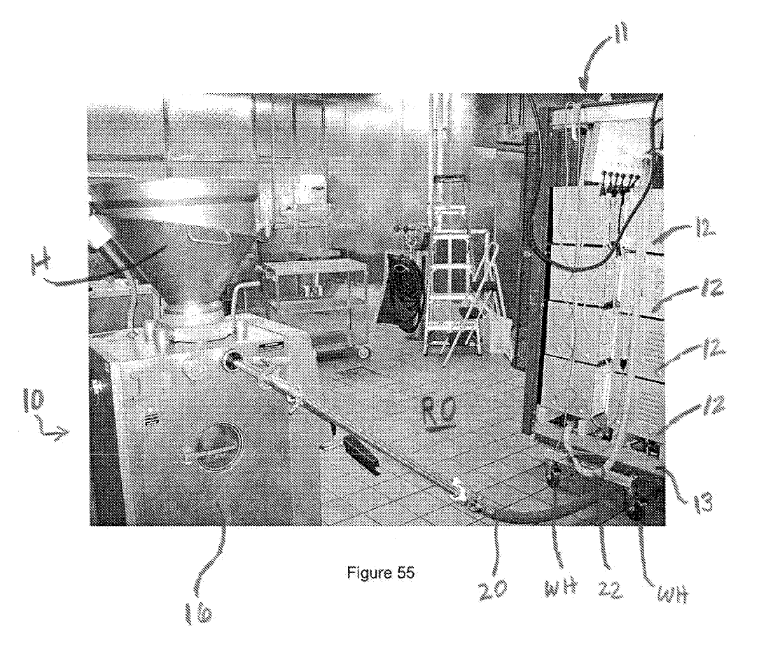

FIG. 52 shows one of the 5 MW unit modules 11 in operation—which can be evidenced visually by the light behind a metal mesh in the upper right corner of microwave cavity 12. If a MW unit 12 stops the heating for any reason, the light in the corner turns off. FIGS. 53 and 55 show a hopper H for a meat paste pump 16 (seen in FIG. 55) loaded with product PR. Pump 16 is used to convey product PR through the heating/pasteurization system 10 comprising four modules 11 via tubing 20 and 22. Particularly, meat paste pump 16 is used to convey the thick viscous material PR through the processing sequence of conduits within multiple MW modules 11. FIG. 54 shows the collection of hot, processed pate product PR in polupropylene pail container 26. In regular production, this stage of product handling would be replaced with a standard product filling station, optionally an aseptic filler, which would desirably be preceded with a cooling stage comprising cooling heat exchangers, such as a tube in tube format of heat exchange.

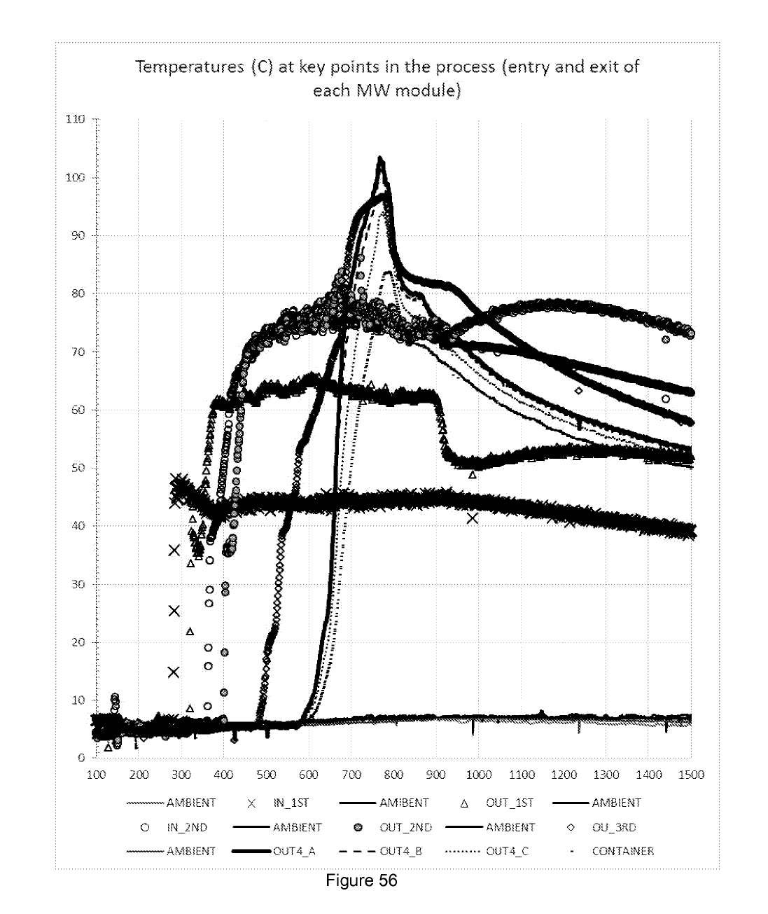

FIG. 56 is a plot of the flowing meat paste temperatures in degrees C. at entry and exit points of each module plus temperature of the paste in the receiving container. FIG. 56 plots the system and product temperatures during a trial run to illustrate the feasibility of flow control, power on and off controls for microwave modules and the incremental temperature rises in each process segment (i.e. mulit-unit MW module), as well as the capacity of the system to deliver the cooking, pasteurization and/or sterilization thermal treatment under the continuous flow conditions.

The ambient temperatures (as well as the temperatures of all process components—units 12, tubing 20 and 22, connectors 30, pump 16) have been allowed to equalize to the refrigeration level temperatures (approx. 4 to 5 degrees C.) of the processing room RO prior to the initiation of processing. Therefore the microwave heating needed not only deliver the thermal treatment to the flowing product PR, but also the preheating of the entire processing system 10 to allow the product to reach the pasteurization or sterilization level temperatures. Since there was no back pressure device installed in system 10, the maximum process temperature allowed by system 10 was slightly over 100 C., i.e. the atmospheric boiling point of water. The recorded temperatures illustrate the incremental increases in each processing element (multi unit modular assemblies 11). The paste PR was introduced from the pump hopper H into the system using the meat paste pump 16 for conveyance. Following the kettle cooking treatment, the paste PR was allowed to equilibrate to approximately 50 C. in order to equilibrate the temperature profile across the entire bulk of material as well as ensure that the volumetric conveyance of pump 16 was stable over the process time.

The volumetric pump flow rate was adjusted to approximately 1 liter per minute—in order to maintain the high rate of heating required to cover the temperature difference from refrigeration (˜5 C.) to full pasteurization (˜105 C.).

Each sensing location had a single sensing point thermocouple 24 installed—including all ambient and all module entry and exit sensor point with the exception of the exit at the top of the last (4^{th}) module 11 in the series which is the location of the fully processed product exit. That location had a single thermocouple probe 24′ (best seen in FIG. 47) with three individual temperature sensing points across the flow profile of the product. They are marked with OUT4_A, OUT4_B and OUT4_C, with OUT4_A at the center of the product flow, OUT4_B placed in the intermediate location between the center and the tube wall and OUT4_C closest to the wall of the tube at the exit of the fourth module 11 (also referred to as Module 4).

FIG. 56 shows that the system was able to achieve full pasteurization treatment with OUT4_A temperature level at 105 C., OUT4_B at 101 C. and OUT4_C at 98 C. Therefore the feasibility of modular microwave systems for pasteurization and/or sterilization of meat based pastes and other food products requiring similar levels of processing treatments has been experimentally confirmed.

### REFERENCES

The references listed below as well as all references, including patents and non-patent literature, cited in the specification are incorporated herein by reference to the extent that they supplement, explain, provide a background for, or teach methodology, techniques, and/or compositions employed herein.

Campanella & Pelegi (1987) 52 J Food Sci 214-217.

Charm (1962) 28 J Food Sci 107-113.

De Kee et al. (1980) 10 J Texture Stud 281-288.

Missaire et al. (1990) 21 J Texture Stud 479-490.

Nakayama et al., (1980) 45 J Food Sci 844-847.

Ofoli et al. (1987) 18 J Texture Stud 213-230.

PCT International Patent Application Publications WO 0036879, WO 0143508, and WO 0184889.

Qui & Rao (1988)53 J Food Sci 1165-1170.

Steffe (1996) Rheoloqical Methods in Food Process Engineering, Second Edition. Freeman Press, East Lansing, Mich., United States of America.

Toledo et al. (1977) 42 J Food Sci 725-727.

U.S. Patent Application Publication Nos. 20010035407 and 20030205576

U.S. Pat. Nos. 4,091,119; 4,808,425; 4,975,246; 5,998,774; 6,087,642; 6,121,594; 6,265,702; 6,406,727; 6,583,395; and 6,797,929

It will be understood that various details of the presently disclosed subject matter can be changed without departing from the scope of the presently disclosed subject matter. Furthermore, the foregoing description is for the purpose of illustration only, and not for the purpose of limitation.

1. A thermal treatment system for a flowable material, the system comprising:
(a) at least two microwave cavities;
(b) an energy source for delivering electromagnetic energy, such as 2450±50 MHz microwave energy, to each of the at least two identical microwave cavities;
(c) a controller for controlling the level of power delivery independently for each of the at least two microwave cavities;
(d) a microwave transparent conduit, optionally a cylindrical conduit, adapted for fluid communication with the at least two microwave cavities to transport a flowable material through the at least two microwave cavities;
(e) a pump for pumping, optionally continuously pumping, a flowable material through the microwave-transparent conduit; and
(f) a component for measuring and/or recording a temperature of a flowable material subsequent to the exposure to electromagnetic energy in the at least two microwave cavities.

2. The thermal treatment system according to claim 1, wherein the at least two microwave cavities are multi-mode microwave cavities.

3. The thermal treatment system according to claim 1, wherein the at least two microwave cavities are identical or are dissimilar.

4. The thermal treatment system according to claim 1, comprising at least two identical and at least one dissimilar multi-mode microwave cavities.

5. The thermal treatment system according to claim 1, comprising a mixing structure disposed within or along the conduit to provide mixing subsequent to the exposure of the flowable material to electromagnetic energy in the at least two microwave cavities.

6. The thermal treatment system according to claim 5, wherein the mixing structure comprises one or more passive mixing structures, one or more active mixing structures, or both.

7. The thermal treatment system according claim 1, comprising a reactor in fluid communication with the conduit to receive the flowable material subsequent to the exposure of the flowable material to electromagnetic energy in the at least two microwave cavities.

8. The thermal treatment system according to claim 7, where the reactor comprises a mixing structure, optionally an active mixing structure.

9. The thermal treatment system according to claim 1, comprising a hold tube adapted for fluid communication with the conduit.

10. The thermal treatment system according to claim 1, comprising a packaging device for one of packaging the flowable material for refrigerated storage, aseptically packaging the flowable material, and both packaging the flowable material for refrigerated storage and aseptically packaging the flowable material.

11. The thermal treatment system according to claim 1, comprising a pre-treating device for providing a pre-treatment to the flowable material prior to the exposure to electromagnetic energy, optionally wherein the pre-treatment is heating, coagulation, mixing, or any combination of the foregoing.

12. The thermal treatment system according to claim 1, wherein the electromagnetic energy is not 915±15 MHz microwave energy.

13. The thermal treatment system according to claim 1, further comprising a mobile enclosure or frame.

14. The thermal treatment system according to claim 1, wherein the mobile enclosure or frame comprises wheels.

15. The thermal treatment system according to claim 1, wherein the system is enclosed within a mobile enclosure or frame.

16. A method of treating a flowable material, the method comprising sequentially exposing the material under continuous flow conditions to electromagnetic energy, such as 2450±50 MHz microwave energy, within at least two microwave cavities while flowing through a conduit, optionally a cylindrical conduit, comprising a microwave-transparent material.

17. The method according to claim 16, wherein the at least two microwave cavities are multi-mode microwave cavities.

18. The method according to claim 16, wherein the at least two microwave cavities are identical or are dissimilar.

19. The method according to claim 16, wherein at least two identical and at least one dissimilar multi-mode microwave cavities are employed.

20. The method according to any claim 16, comprising mixing the flowable material subsequent to the exposure to electromagnetic energy in the at least two microwave cavities.

21. The method according to claim 20, wherein the mixing employs one or more passive mixing structures, one or more active mixing structures, or both.

22. The method according to claim 16, comprising flowing the flowable material to a reactor in fluid communication with the conduit to receive the flowable material subsequent to the exposure of the flowable material to electromagnetic energy in the at least two microwave cavities.

23. The method according to claim 22, where the reactor comprises a mixing structure, optionally an active mixing structure.

24. The method according to claim 16, comprising holding the flowable material in a hold tube adapted for fluid communication with the conduit.

25. The method according to claim 16, comprising one of packaging the flowable material for refrigerated storage, aseptically packaging the flowable material, and both packaging the flowable material for refrigerated storage and aseptically packaging the flowable material.

26. The method according to claim 16, comprising a pre-treating the flowable material prior to the exposure to electromagnetic energy, optionally wherein the pre-treatment is heating, coagulating, mixing, or any combination of the foregoing.

27. The method according to claim 16, wherein the flowable material is selected based on at least one of rheological, dielectric, and thermophysical properties, or combinations thereof, of the flowable material.

28. The method according to claim 16, wherein the flowable material is a biomaterial.

29. The method according to claim 16, wherein the flowable material is exposed to the treatment by any one of the components comprising the system more than once

30. The method according to claim 16, wherein the flowable material is selectively exposed to the treatment by more than one of the components comprising the system more than once

31. The method of claim 30, wherein the biomaterial is a food biomaterial.

32. The method of claim 31, wherein the food biomaterial is selected based on at least one of rheological, dielectric, and thermophysical properties, or combinations thereof, of the food biomaterial.

33. The method according to claim 16, wherein the electromagnetic energy is not 915±15 MHz microwave energy.

34. A product produced by the method according to claim 16.

35. A commercially sterile biomaterial comprising comminuted protein rich material and having one or more quality attributes that is preserved to a greater extent as compared to a reference biomaterial that has been sterilized using a reference thermal treatment method.

36. The food biomaterial of claim 35, wherein the one or more quality attributes is selected from the group consisting of nutrient content, color, texture, flavor and general appearance.
